(19) United States
(12) Patent Application Publication
(10) Pub. No.: US 2017/0351713 A1
(43) Pub. Date: Dec. 7, 2017

(54) IMAGE PROCESSING SYSTEMS AND/OR METHODS

(71) Applicants: Robin Daniel CHAMBERLAIN, Melbourne (AU); Hamish Charles ROBERTSON, Montmorency (AU)

(72) Inventors: Robin Daniel CHAMBERLAIN, Melbourne (AU); Hamish Charles ROBERTSON, Montmorency (AU)

(21) Appl. No.: 15/610,820

(22) Filed: Jun. 1, 2017

Related U.S. Application Data
(60) Provisional application No. 62/345,189, filed on Jun. 3, 2016.

(51) Int. Cl. G06F 17/30; G06T 7/11; G06K 9/62; G06K 9/20; G06T 11/60

(52) U.S. Cl. CPC G06F 17/30268; G06K 9/2081; G06F 17/30256; G06T 11/60; G06K 9/6202; G06T 7/11; G06F 17/3087; G06F 17/3028; G06T 2200/24; G06T 2207/10024

(57) ABSTRACT

The present invention provides a method (100,200) for identifying, retrieving and/or processing one or more images (12ₙ) from one or more source network locations (14ₙ) for display at one or more predetermined target network locations (16ₙ). The method includes the steps of: acquiring an address (36ₙ) for each of the one or more source network locations (14ₙ); perusing data available at each of the one or more source network locations (14ₙ) to identify one or more images (12ₙ) suitable for display at the one or more target network locations (16ₙ); retrieving any images (12ₙ) identified as being suitable for display at the one or more target network locations (16ₙ); processing the retrieved images (12ₙ), as required or desired, in order to adapt the images (12ₙ) for display at the one or more target network locations (16ₙ); and, selectively displaying the retrieved and/or processed image or images (12ₙ) at the one or more target network locations (16ₙ). Also provided is an associated system (10) for use with the method (100,200) of the invention.

### CROSS-REFERENCE

This application claims benefit of and priority to, U.S. Provisional Patent Application Ser. No. 62/345,189, filed on 3 Jun. 2016, the disclosure of which is hereby incorporated by reference in its entirety.

### TECHNICAL FIELD

The present invention relates generally to image processing systems and/or methods, and relates particularly, though not exclusively, to systems and/or methods for identifying, retrieving and processing one or more images from one or more source network locations for display at one or more predetermined target network locations. More particularly, the present invention relates to a system and/or method for identifying, retrieving and processing one or more images from one or more source network locations for display within a search results screen or page of a search engine graphical user interface (hereinafter simply referred to as “GUI”) after a search has been performed.

It will be convenient to hereinafter describe the invention in relation to a system and/or method for identifying, retrieving and processing images for display within a search results screen or page of a search engine GUI after a search has been performed, however, it should be appreciated that the present invention is not limited to that use only. For example, the image processing systems and/or methods of the present invention could also be used for a range of other network or online services, such as, for example, social media services and/or image aggregation sites or services. A skilled person will appreciate many possible uses and modifications of the systems and/or methods of the present invention. Accordingly, the present invention as hereinafter described should not be construed as limited to any one or more of the specific examples provided herein, but instead should be construed broadly within the spirit and scope of the invention as defined in the description and claims that now follow.

### BACKGROUND ART

Any discussion of documents, devices, acts or knowledge in this specification is included to explain the context of the invention. It should not be taken as an admission that any of the material forms a part of the prior art base or the common general knowledge in the relevant art in the United States of America, or elsewhere, on or before the priority date of the disclosure herein.

Unless stated otherwise, throughout the ensuing description, the expression “image(s)” is/are intended to refer to any suitable two or three dimensional digital representation of an object(s), thing(s), or symbol(s), etc., which is stored in the form of a data file (of any suitable file format, such as, for example, the so-called JPEG, PNG, TIFF, GIF, EPS, AI, PDF, AVI, WMV, SVG, MOV, MP4, etc. file formats) and which may be identified, retrieved, processed and displayed in accordance with the present invention. Each digital image used in accordance with the present invention is composed of pixels arranged in an array, such as, for example, a generally rectangular array with a certain height and width. Each pixel consists of one or more bits of information, including brightness and colour information, that can be analysed and manipulated by a computer processing system. Suitable images may include, but are not limited to, still images, such as, for example, pictures, photographs, holograms, or logos (any of which may be in two or three dimensional form), or moving images, such as, for example, videos, movies or animations (again, any of which may be in two or three dimensional form). Similarly, the expression “source network location(s)” is/are intended to refer to any suitable network location at which there may reside one or more image(s) that may be identified, retrieved and processed in accordance with the present invention. Source network locations may include, but are not limited to, websites or web-pages that include text and/or images. Finally, the expression “target network location(s)” is/are intended to refer to any suitable network location at which the image or images retrieved and processed from the source network location or locations may be displayed as desired in accordance with the present invention. A target network location may include, but is not limited to, a search engine GUI residing on a user operable terminal. A skilled person will appreciate many suitable image(s), source and target network location(s), along with combinations, substitutions, variations or alternatives thereof, applicable for use with the system and/or method of the present invention. Accordingly, the present invention should not be construed as limited to any one or more of the specific examples provided herein. Finally, the definitions of the expressions hereinbefore described are only provided for assistance in understanding the nature of the invention, and more particularly, the preferred embodiments of the invention as hereinafter described. Such definitions, where provided, are merely examples of what the expressions refer to, and hence, are not intended to limit the scope of the invention in any way.

There is an enormous amount of data available via the World Wide Web (herein after simply referred to as “WWW” or the “web”) and the sheer volume of data continues to grow every day. In recent years, with the growth of broadband, social media and devices such as, for example, smart phones which incorporate cameras, there has been an explosion of images (including still and moving image files) appearing around the web. Unlike text-based data which can be identified, retrieved, stored and searched efficiently by way of, for example, indexing the text-based data in a search engine database(s), images (especially high quality still image files, animations or video files) require a vast amount of storage space which makes it costly or at least difficult to retrieve and store a copy of the available images within a traditional search engine database. This problem is exacerbated when search engines regularly check for updates of images, or look for new images, in an attempt to keep their indexing database(s) up to date.

Aside from the issues associated with retrieving and storing images using traditional search engine indexing techniques, problems can also arise when it is desired to display one or more images (retrieved from one or more source network locations) at a predetermined target network location. One such problem concerns the rapidly increasing use of partially transparent raster images or vector graphics images (i.e. images with both colour and transparent pixels, or images with areas of both colour pixels and no or empty pixels, such as, for example, an image of an object, etc., with no background colour) throughout the web. Throughout the ensuing description, the expression “partially transparent image(s)” is/are intended to refer to any suitable image (including raster or vector graphics file formatted images) which includes regions or pixels of both colour and no colour, i.e. regions of transparency or transparent pixels). With the proliferation of the so-called responsive web design (hereinafter simply referred to as “RWD”) approach to designing websites, and hence the need to be able to readily move images over the top of other images and/or elements of a web-page dynamically to accommodate different screen sizes, etc., partially transparent images are now generally considered essential items to web designers. Common partially transparent images include logos which are often overlaid on blocks of background colour or photography. Such partially transparent images provide a useful function for modern mobile responsive websites as they can be resized and moved across the background and/or other elements of a web-page to readily optimise the viewing and interactive experience of the website. Although very useful tools when it comes to RWD, partially transparent images are not generally designed to be extracted from their source location and displayed elsewhere. Of course, it is possible to readily retrieve and display partially transparent images at a different network location, however without knowing their intended background colour, etc., the images will not be displayed as intended by the respective website owner(s), etc. One solution when dealing with partially transparent images is to generate a neutral background colour, such as, for example, a selected shade of grey, as a default background colour for all partially transparent images. This approach has its limitations in that the selected default background colour may in some cases result in the background creating little or no contrast to the non-transparent portion of the retrieved image, which will ultimately result in a poor viewing experience.

A need therefore exists for an improved image processing system and/or method, one which overcomes or alleviates one or more of the aforesaid problems associated with known image processing systems and/or methods, or one which at least provides a useful alternative. More particularly, a need exists for an improved image processing system and/or method for identifying, retrieving and processing one or more images from one or more source network locations for display at one or more predetermined target network locations.

### DISCLOSURE OF THE INVENTION

According to one aspect, the present invention provides a method for identifying, retrieving and/or processing one or more images from one or more source network locations for display at one or more predetermined target network locations, the method including the steps of: acquiring an address for each of the one or more source network locations; perusing data available at each of the one or more source network locations to identify one or more images suitable for display at the one or more target network locations; retrieving any images identified as being suitable for display at the one or more target network locations; processing the retrieved images, as required or desired, in order to adapt the images for display at the one or more target network locations; and, selectively displaying the retrieved and/or processed image or images at the one or more target network locations.

Preferably, the step of acquiring an address for each of the one or more source network locations includes: performing a network and/or database search in response to a search query; identifying one or more source network locations that contain data related to the search query; and, obtaining at least the address for each of the one or more source network locations that were identified as part of the network and/or database search.

Preferably, the method further includes the step of: obtaining and/or compiling text-based search results data from/for each of the one of more source network locations that were identified as part of the network and/or database search.

Preferably, the step of perusing data available at each of the one or more source network locations to identify one or more images suitable for display at the one or more target network locations includes: utilising the acquired address or addresses to send network crawlers or algorithmic commands to each of the one or more source network locations to identify and analyse any available images for suitability for display at the one or more target network locations.

Preferably, the method further includes the step of: obtaining and/or compiling text-based data associated with one or more images identified and analysed at each of the one or more source network locations. It is also preferred that the text-based data associated with the one or more images identified and analysed at each of the one or more source network locations includes: text-based data extracted from metadata of the one or more images; text-based data associated with and displayed alongside the one or more images at their respective one or more source network locations; and/or, text-based data extracted from metadata contained within modules, fields, graphic tiles, blocks or regions provided at the respective one or more source network locations.

Preferably, the step of identifying one or more images suitable for display at the one or more target network locations includes one or more of the following processes: utilising advanced data mining, deep learning, machine learning and/or artificial intelligence to make informed decisions about the existence and suitability of any images available at each source network location; mining source code data and/or embedded link data available at each source network location to determine the size and order of any available images in order to make decisions about the most appropriate or suitable image or images available at each source network location; utilising individual or aggregated user data to make determinations about the most appropriate or suitable image or images available at each source network location; ignoring images of a predetermined and/or unusual shape and/or size; recognising any advertisements and/or third party embedded logos at each source network location and ignoring any images associated with the/those advertisement/third party logos in favour of the selection of other images available at each source network location; utilising one or more commonly accepted image tagging protocols to determine the existence and suitability of any images available at each source network location; scanning and/or analysing metadata of any available image or images to determine the most appropriate or suitable image or images available at each source network location; and/or, analysing and comparing the characteristics of any available images to that of the characteristics of offensive images to make determinations about the most appropriate or suitable image or images available at each source network location.

Preferably, the step of retrieving any images identified as being suitable for display at the one or more target network locations includes: selectively compressing or reducing the size of the image or images prior to or during retrieval so as to reduce computational overhead or bandwidth usage.

If it is determined that there is no suitable image or images available at one or more of the source network locations, then it is preferred that the method further includes the step of: obtaining and/or generating a predetermined image or images for each of those source network locations so that the predetermined image or images may be displayed at the one or more target network locations.

If it is determined that one or more suitable moving images are available at one or more of the source network locations, then it is preferred that the method further includes the steps of: acquiring the identification sting or source location details for each of the moving images; obtaining and/or generating a thumbnail or other suitable image for each of the moving images for display at the one or more target network locations; and, utilising the acquired identification string or source location details to enable each of the moving images or a portion thereof to be selectively or automatically played at the one or more target network locations by way of selective or automatic activation of the respective thumbnail or other suitable image.

Preferably, the step of processing the retrieved images, as required or desired, in order to adapt the images for display at the one or more target network locations includes one or more of the following processes: analysing the pixels of each image to determine the highest variation area of pixels, selecting a region of predetermined dimensions surrounding the highest pixel variation area, and then adapting each image by removing the portions of each image that are outside of the selected region; analysing the file name and/or metadata of each image in order to locate a specified predetermined pixel point which identifies a desired portion of the image that is to be used for display at the one or more target network locations, selecting a region of predetermined dimensions surrounding the specified predetermined pixel point, and then adapting each image by removing the portions of each image that are outside of the selected region; allowing one or more users to select a region of predetermined dimensions surrounding a desired area of each image, and then adapting each image by removing the portions of each image that are outside of the selected region; analysing one or more pixels of each image to determine whether or not an image contains areas of transparent or no pixels, and if it is determined that an image contains areas of transparent or no pixels, adapting the image by adding a predetermined contrasting background colour(s) and/or effect(s) to the image; and/or, analysing the pixels of any partially transparent images in order to determine the portion and/or size of the non-transparent pixels in relation to the total size of the image, selecting a region of predetermined dimensions surrounding the most appropriate portion of the image which contains non-transparent pixels, and then adapting each image by removing the portions of each image that are outside of the selected region.

Preferably, the predetermined contrasting background colour(s) and/or effect(s) that is added to one or more of the images determined to contain areas of transparent or no pixels is selected, generated and/or added by way of one or more of the following processes: analysing the non-transparent pixels of the respective image and generating and adding a contrasting coloured background, or drop shadow or visual effect, to the image which enhances the viewing experience of the non-transparent pixels of the image; mining source code data available at the source network location that corresponds to the respective image, and generating and adding a contrasting coloured background, or drop shadow or visual effect, to the image which corresponds to, or complements, a theme or dominant feature of other data residing at the source network location; and/or, analysing the file name and/or metadata of the respective image in order to locate specified predetermined background information which identifies a desired background colour(s), or drop shadow or visual effect that is to be used with that image, and generating and adding a contrasting coloured background, or drop shadow or visual effect, to the image which corresponds to that specified predetermined background information.

Preferably, the process of analysing the pixels or areas of any partially transparent images in order to determine the portion and/or size of the non-transparent pixels in relation to the total size of the image, selecting a region of predetermined dimensions surrounding the most appropriate portion of the image which contains non-transparent pixels, and then adapting each image by removing the portions of each image that are outside of the selected region, further includes one or both of the following steps: reducing the viewable area of the portion of the image that corresponds to the selected region, to a percentage smaller than the full width and/or height of the predetermined dimensions, so as to generate a border area around the non-transparent pixels of each image; and/or, centering the non-transparent pixel content within the selected region of predetermined dimensions prior to removing the portions of each image that are outside of the selected region.

Preferably, the method further includes the step of: selectively and/or temporarily storing the retrieved and/or processed image or images, the obtained and/or generated predetermined image or images, the text-based search results data, the text-based data associated with the one or more images identified and analysed at each of the one or more source network locations, and/or data pertaining thereto, in at least one repository, so as to streamline future processing in instances where the same source network locations are identified as part of a future network and/or database search.

In a practical preferred embodiment, the one or more target network locations preferably include one or more network and/or database search applications or GUIs residing on one or more user operable terminals.

Preferably, the step of selectively displaying the retrieved and/or processed image or images at the one or more target network locations includes: selectively displaying the retrieved and/or processed image or images, and/or the obtained and/or generated predetermined image or images, within the one or more network and/or database search applications or GUIs after a network and/or database search has been performed.

Preferably, for each source network location that was identified as part of the network and/or database search, the retrieved and/or processed image or images, and/or the obtained and/or generated predetermined image or images, that correspond to that source network location are disposed within at least one activatable tile or region which when selectively or automatically activated links through to the respective source network location.

Preferably, for each source network location that was identified as part of the network and/or database search, the obtained text-based search results data and/or the obtained text-based data associated one or more images identified and analysed at the source network location, is/are selectively displayed alongside the corresponding retrieved and/or processed image or images, and/or the corresponding obtained and/or generated predetermined image or images, within the at least one activatable tile or region.

Preferably, the method further includes the step of: for each source network location that was identified as part of the network and/or database search, audibly conveying the obtained text-based search results data and/or the obtained text-based data associated with the one or more images identified and analysed at the source network location, upon request, or upon it being determined that a user is viewing the corresponding retrieved and/or processed image or images, and/or the corresponding obtained and/or generated predetermined image or images, disposed within the at least one activatable tile or region.

Preferably, upon selective or automatic activation of the at least one activatable tile or region corresponding to a selected source network location, network content available at that selected source network location is displayed alongside, and simultaneously with, at least selected ones of the activatable tiles or regions so that those activatable tiles or regions remain accessible to a user should they wish to access and view network content associated with a different source network location. It is also preferred that the activatable tiles or regions are disposed within a region, sidebar or frame of the one or more network and/or database search applications or GUIs.

According to a further aspect, the present invention provides a non-transitory computer readable medium storing a set of instructions that, when executed by a machine, cause the machine to execute a method for identifying, retrieving and/or processing one or more images from one or more source network locations for display at one or more predetermined target network locations, the method including the steps of: acquiring an address for each of the one or more source network locations; perusing data available at each of the one or more source network locations to identify one or more images suitable for display at the one or more target network locations; retrieving any images identified as being suitable for display at the one or more target network locations; processing the retrieved images, as required or desired, in order to adapt the images for display at the one or more target network locations; and, selectively displaying the retrieved and/or processed image or images at the one or more target network locations.

According to yet a further aspect, the present invention provides a system for identifying, retrieving and/or processing one or more images from one or more source network locations for display at one or more predetermined target network locations, the system including: one or more modules or applications for acquiring an address for each of the one or more source network locations and/or one or more modules, applications or functions for selectively activating one or more external modules or applications for returning an acquired address for each of the one or more source network locations; one or more modules or applications for perusing data available at each of the one or more source network locations and for identifying and retrieving one or more images suitable for display at the one or more target network locations; one or more modules or applications for processing the retrieved images, as required or desired, in order to adapt the images for display at the one or more target network locations; and, one or more modules or applications for selectively displaying the retrieved and/or processed image or images at the one or more target network locations.

According to still yet a further aspect, the present invention provides a method for selecting a desired region of an image to be displayed at one or more predetermined target network locations, the image having specified predetermined pixel point information included within its file name and/or metadata which identifies the desired region of the image that is to be used for display at the one or more target network locations, the method including the steps of: analysing the file name and/or metadata of the image in order to locate the specified predetermined pixel point information; selecting a region of predetermined dimensions surrounding, or adjacent to, the specified predetermined pixel point information; and, adapting the image by removing the portions of the image that are outside of the selected region so that only the desired region of the image may then be displayed at the one or more predetermined target network locations.

According to still yet a further aspect, the present invention provides a method for generating and adding a desired contrasting background colour(s) and/or effect to a partially transparent image, the partially transparent image having specified predetermined background information included within its file name and/or metadata which identifies the desired contrasting background colour(s) and/or effect, the method including the steps of: analysing the file name and/or metadata of the image in order to locate the specified predetermined background information; and, generating and adding a contrasting coloured background and/or effect to the image which corresponds to that specified predetermined background information.

These and other essential or preferred features of the present invention will be apparent from the description that now follows.

### BRIEF DESCRIPTION OF THE DRAWINGS

In order that the invention may be more clearly understood and put into practical effect there shall now be described in detail preferred constructions of an image processing system and/or method made in accordance with the invention. The ensuing description is given by way of non-limitative examples only and is with reference to the accompanying drawings, wherein:

FIG. 1 is a block diagram of an image processing system made in accordance with a preferred embodiment of the present invention;

FIG. 2 is an exemplary search engine GUI illustrating a preferred way in which one or more images may be processed and displayed alongside text-based search results data after a search has been performed, the exemplary search engine GUI being suitable for use with the preferred image processing system shown in FIG. 1;

FIG. 3a is a flow diagram illustrating a preferred embodiment of an image processing method which is suitable for use with the preferred image processing system shown in FIG. 1;

FIG. 3b is a flow diagram illustrating an alternative preferred embodiment of an image processing method which is also suitable for use with the preferred image processing system shown in FIG. 1;

FIGS. 4a to 4c illustrate, in preferred steps, how an image retrieved from a source network location may be manipulated for display at a predetermined target network location in accordance with the preferred image processing system and/or methods shown in FIGS. 1, 3a & 3b;

FIGS. 5a & 5b illustrate, again in preferred steps, how one or more background colour(s), etc., may be added to a partially transparent image retrieved from a source network location, before that image is displayed at a predetermined target network location, in accordance with the preferred image processing system and/or methods shown in FIGS. 1, 3a & 3b;

FIGS. 6a & 6b illustrate, yet again in preferred steps, how a partially transparent image retrieved from a source network location may be manipulated, and a background colour(s), etc., added thereto, before that image is displayed at a predetermined target network location, in accordance with the preferred image processing system and/or methods shown in FIGS. 1, 3a & 3b;

FIG. 7 is an alternative exemplary search engine GUI illustrating a preferred way in which one or more images may be processed and displayed alongside text-based search results data and the actual network content (available at the respective source network location) corresponding to one of the search results, after a search has been performed, the exemplary search engine GUI also being suitable for use with the preferred image processing system shown in FIG. 1;

FIG. 8 is a further alternative exemplary search engine GUI illustrating a preferred way in which multiple images may be processed and displayed alongside their corresponding text-based search results data after a search has been performed, the exemplary search engine GUI also being suitable for use with the preferred image processing system shown in FIG. 1;

FIG. 9 is yet a further alternative exemplary search engine GUI illustrating a preferred way in which multiple images may be processed and displayed alongside their corresponding text-based search results data after a search has been performed, the exemplary search engine GUI also being suitable for use with the preferred image processing system shown in FIG. 1; and,

FIG. 10 is yet a further alternative exemplary search engine GUI illustrating a preferred way in which only one or more images may be processed and displayed after a search has been performed, the exemplary search engine GUI also being suitable for use with the preferred image processing system shown in FIG. 1.

### MODES FOR CARRYING OUT THE INVENTION

In the following detailed description of the invention, reference is made to the drawings in which like reference numerals refer to like elements throughout, and which are intended to show by way of illustration specific embodiments in which the invention may be practiced. It is to be understood that other embodiments may be utilised and that procedural and/or structural changes may be made without departing from the spirit and scope of the invention.

Unless specifically stated otherwise as apparent from the following discussion, it is to be appreciated that throughout the description, discussions utilising terms such as “processing”, “computing”, “calculating”, “acquiring”, “transmitting”, “receiving”, “retrieving”, “identifying”, “determining”, “manipulating” and/or “displaying”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Discussions regarding apparatus for performing the operations of the invention are provided herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), erasable programmable read-only memory (EPROMs), electrically erasable programmable read-only memory (EEPROMs), magnetic or optical cards, or any type of media suitable for storing electronic instructions, and each coupled to a computer system bus.

The software modules, engines or applications, and displays presented or discussed herein are not inherently related to any particular computer or other apparatus. Various general purpose systems may be used with programs in accordance with the teachings herein, or it may prove convenient to construct more specialised apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

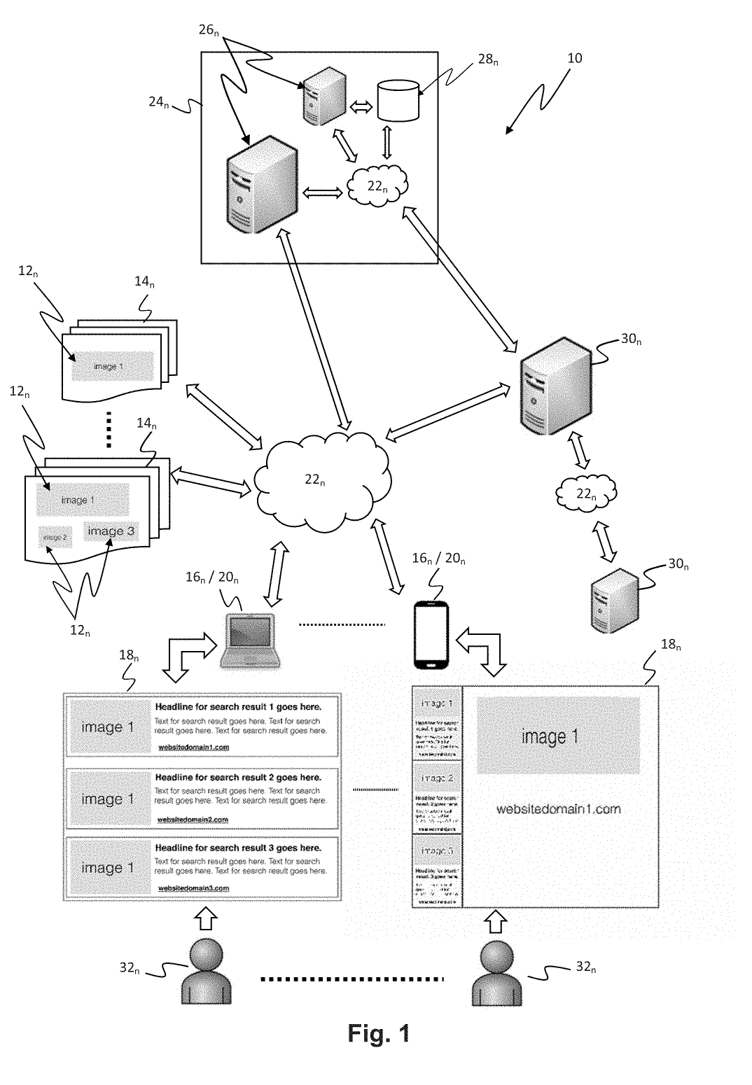

In FIG. 1 there is shown a preferred system 10 for identifying, retrieving and/or processing one or more images 12ₙ from one or more source network locations 14ₙ, such as, for example, one or more websites or web-pages 14ₙ as shown, for display at one or more predetermined target network locations 16ₙ, such as, for example, within one or more GUI's 18ₙ installed on a user operable terminal 20ₙ as shown. System 10 is suitable for use over a communications network 22ₙ, such as, for example, the Internet or web 22ₙ, as shown. It should be understood however, that system 10 of the present invention is not limited to that use only.

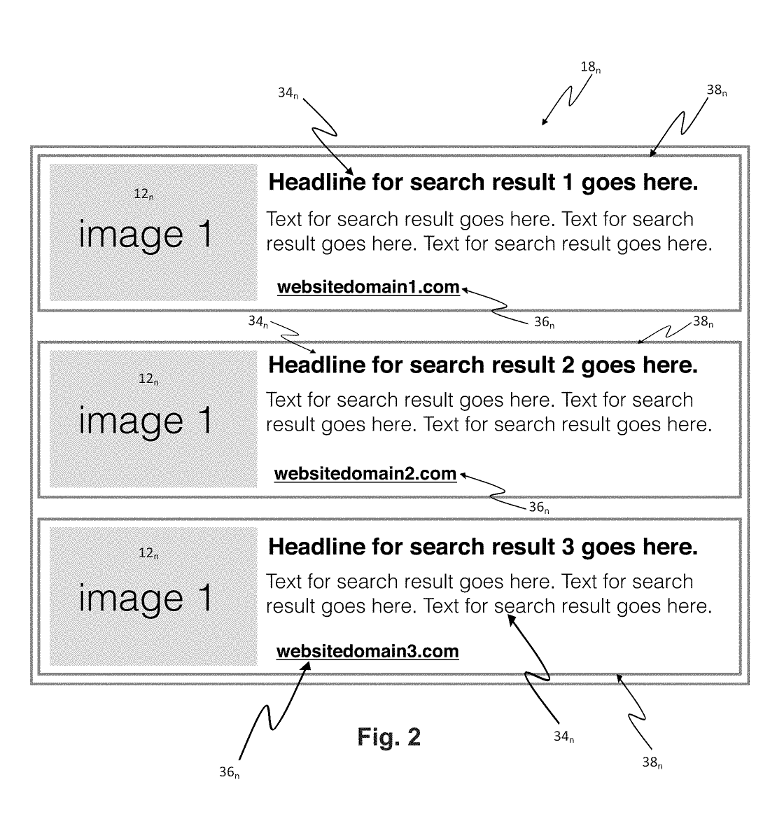

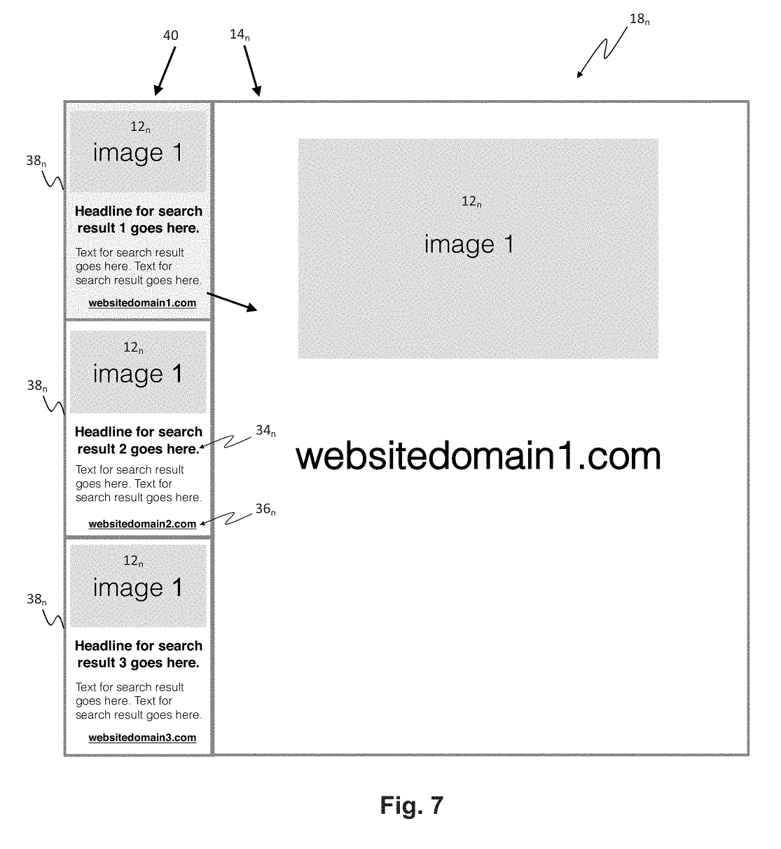

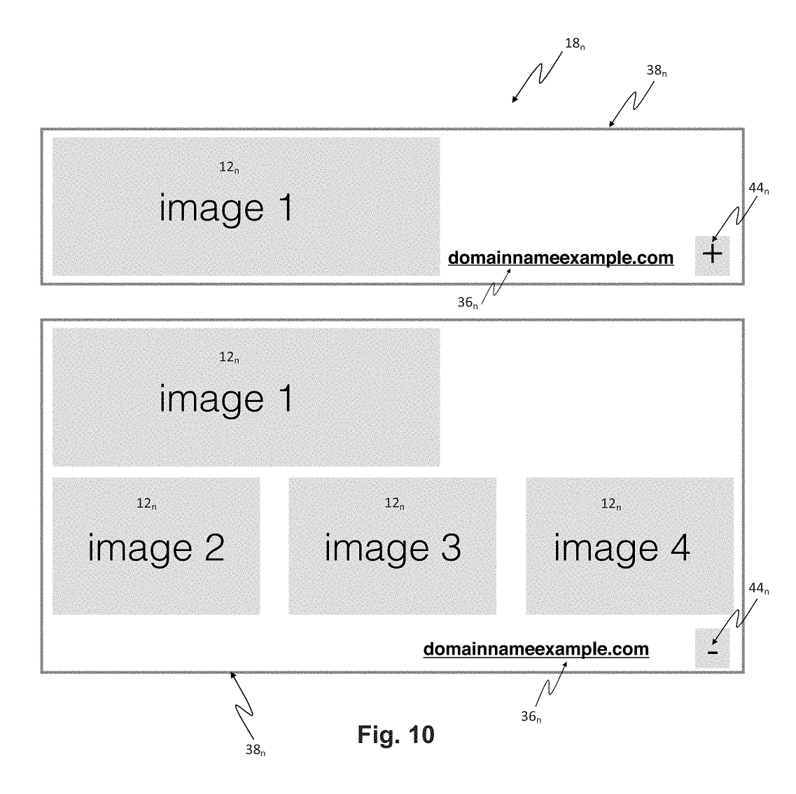

In the preferred embodiments shown in the drawings, system 10 is specifically configured for identifying, retrieving and processing images 12ₙ for display within a search results screen or page of a search engine GUI 18ₙ after a search has been performed. As will be described in further detail below, the retrieved images 12ₙ may be displayed (within search engine GUI 18ₙ) alongside corresponding text-based or other search results data (see, for example, FIGS. 2 & 7 to 9) retrieved as part of a search request and/or retrieved as part of the process of identifying and retrieving the image(s) 12ₙ from the one or more source network location(s) 14ₙ, or may be displayed by themselves, or with limited information associated with their source network location 14ₙ (e.g. the source location 14ₙ URL, etc.), after a search has been performed (see, for example, FIG. 10). In yet a further preferred embodiment, the retrieved images 12ₙ (with or without any other corresponding text-based or search results data or source network location 14ₙ data or information) may be displayed alongside the actual network content (available at the respective source network location 14ₙ) corresponding to one of the search results, after a search has been performed (see, for example, FIG. 7). Although specific search engine based embodiments are shown and described herein, it should be appreciated that the present invention is not limited to that use, or those examples, only.

System 10 includes at least one network server 24ₙ, which in the present embodiment is a search engine or network search service or provider 24ₙ, and which includes at least one computing device 26ₙ, which may host and/or maintain a plurality of tools or applications (not shown, but which may be, for example, software and/or hardware modules or applications, etc.) and databases/storage devices 28ₙ, that together at least provide a means of searching communications network(s) 22ₙ, but which may also provide a means of identifying, retrieving and/or processing one or more images 12ₙ (and any desired available associated data, e.g. text-based data associated with an image(s) 12ₙ, as will be described in further detail below), from one or more source network locations 14ₙ, for display at one or more predetermined target network locations 16ₙ, such as, for example, within one or more search engine GUI's 18ₙ installed on a user operable terminal 20ₙ, as shown in FIG. 1.

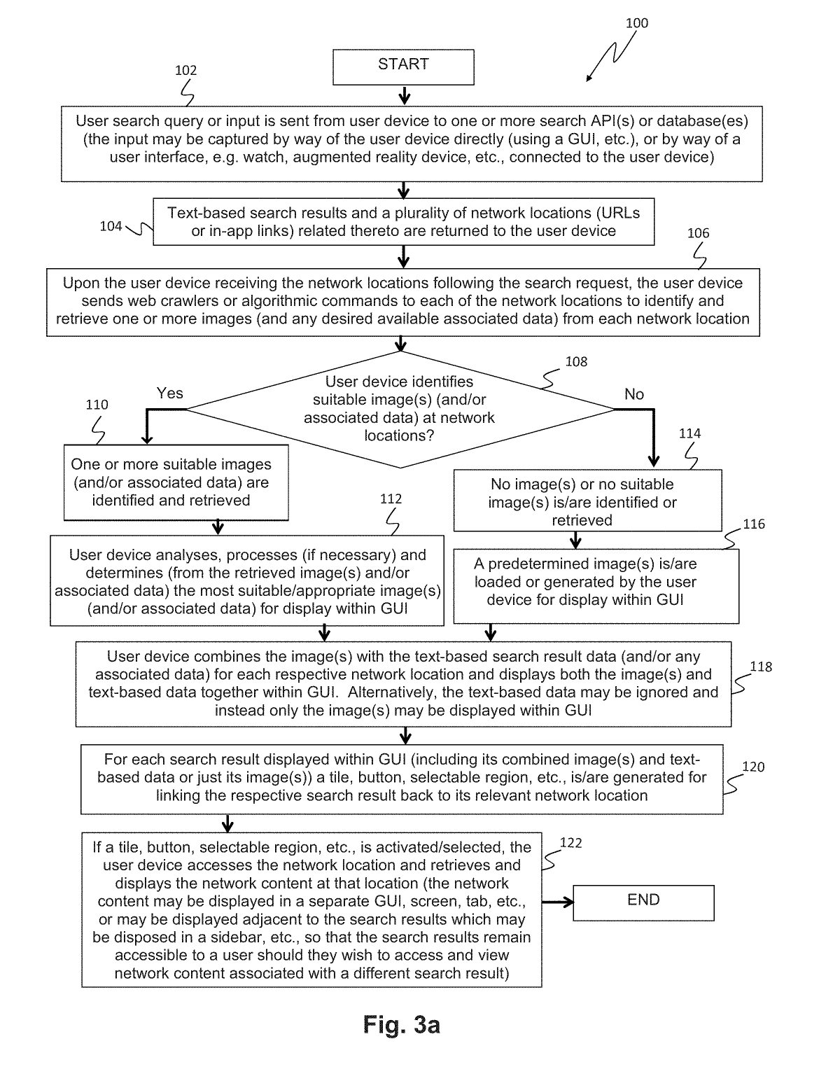

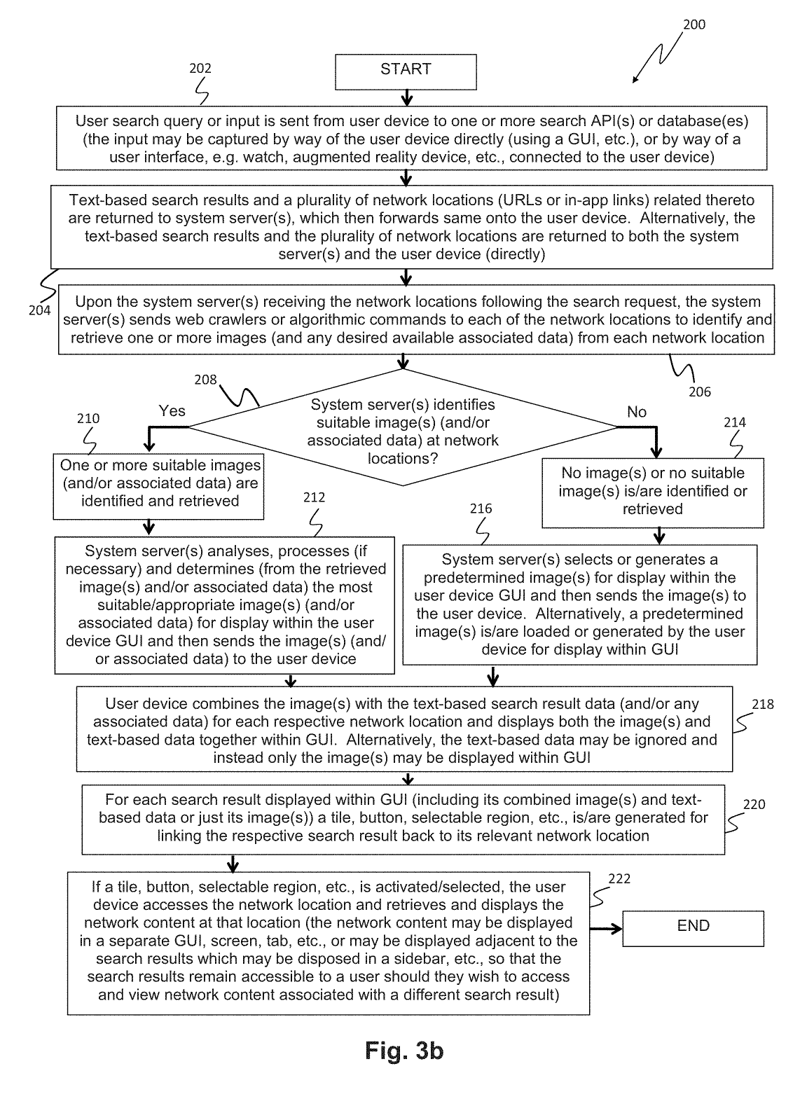

As will be described in further detail below with reference to the preferred flow diagrams of FIGS. 3a & 3b, network server 24ₙ of system 10 may only be required to perform search functions so as to, for example, retrieve text-based search results data along with details of the associated source network locations 14ₙ (e.g. the address or URL of each source network location 14ₙ—see, for example, FIG. 3a), or may also be required to subsequently, or substantially simultaneously, retrieve and process (as needed) the images 12ₙ (and any desired available associated data) for display within search engine GUI(s) 18ₙ (see, for example, FIG. 3b). That is, the image 12ₙ identification, retrieval and processing steps (hereinafter simply referred as “image processing steps”, “image 12ₙ processing”, etc.) of the present invention may be performed by/at either the user operable terminal 20ₙ (FIG. 3a) or the network server 24ₙ (FIG. 3b), or by/at a combination of the user operable terminal 20ₙ and network server 24ₙ (not shown). For example, network server 24ₙ side image 12ₙ processing may be adopted in instances where it is desired to have the server 24ₙ doing the heavy lifting (e.g. identifying, retrieving, analysing and processing of images 12ₙ, and any desired available associated data), or in instances where the network server 24ₙ has a much faster connection to the communications network 22ₙ, meaning it is far more feasible for network server 24ₙ to be doing the image 12ₙ processing steps. Likewise, depending on the type, power and connection speed, etc., of a user operable terminal 20ₙ, the image 12ₙ processing steps may readily be performed at/by software and/or hardware (e.g. an App or other software and/hardware application or module—not shown) installed on the user operable terminal 20ₙ. A person skilled in the relevant art will appreciate many such server 24ₙ and/or user operable terminal 20ₙ side embodiments, modifications, variations and alternatives therefor, and as such the present invention should not be construed as limited to any of the examples provided herein and/or described with reference to the drawings.

Network server 24ₙ is configured to receive/transmit data, including at least search request and results data, from/to at least one user operable terminal 20ₙ, via communications network 22ₙ. The term “user operable terminal(s) 20ₙ” refers to any suitable type of computing device or software application, etc., capable of transmitting, receiving, conveying and/or displaying data as described herein, including, but not limited to, a mobile or cellular phone, a smart phone, an App (e.g. iOS or Android) for a smart phone, a smart watch or other wearable electronic device, an augmented reality device (such as, for example, an augmented reality headset, eyeglasses or contact lenses, etc.), a connected Internet of Things (“IoT”) device; a Personal Digital Assistant (PDA), and/or any other suitable computing device, as for example a server, personal, desktop, tablet, or notebook computer.

As already discussed above, network server 24ₙ is designed to at least perform search functions so as to, for example, retrieve text-based search results data from, and along with, details of associated source network locations 14ₙ (e.g. the URL of each source network location 14ₙ) available via communications network 22ₙ, in response to search requests submitted via a user operable terminal 20ₙ (either directly, or by way of, for example, a search engine application programming interface, hereinafter simply referred to as “API(s)”), and to return the search results data, etc., to user operable terminal(s) 20ₙ. Should network server 24ₙ side image 12ₙ processing be desired, then network server 24ₙ would also be configured to identify, retrieve, analyse and/or process (if necessary) images 12ₙ (and any desired available associated data) before providing those images 12ₙ (and any desired available associated data) to user operable terminal(s) 20ₙ.

As is shown in FIG. 1, network server 24ₙ and/or user operable terminals 20ₙ may also be configured to receive/transmit data from/to at least one external software provider or server 30ₙ (hereinafter simply referred to as “external server(s) 30ₙ”), via communications network 22ₙ. The term “external server(s) 30ₙ” refers to any suitable external service/software provider that may be utilised in accordance with the present invention. External server(s) 30ₙ may include, but are not limited to: other search, social media or data API or similar providers, or servers hosting data desired to be searched, such as, for example, Wikipedia, Facebook or Twitter, which may be necessary, or desired, to find relevant source network locations 14ₙ in response to a search request received from a user operable terminal 20ₙ; one or more servers (which may host and/or maintain a plurality of tools or applications—not shown, but which may be, for example, software and/or hardware modules or applications, etc.—that together provide a means of identifying, retrieving and/or processing one or more images 12ₙ (and any desired available associated data, e.g. text-based data associated with an image(s) 12ₙ, as will be described in further detail below), from one or more source network locations 14ₙ, for display at one or more predetermined target network locations 16ₙ) configured specifically to perform at least the image 12ₙ processing steps of the present invention; and/or, any other suitable software or data providers (whether cloud based, or otherwise) that may provide associated or desired software or data that may be accessed or otherwise used by system 10 for the purpose of identifying, retrieving and processing one or more images 12ₙ (and any desired available associated data) from one or more source network locations 14ₙ for display at one or more predetermined target network locations 16ₙ, in accordance with the invention.

User operable terminals 20ₙ are each configured to be operated by at least one user 32ₙ of system 10. The term “user 32ₙ” refers to any person in possession of, or stationed at, at least one user operable terminal 20ₙ whom is able to operate the user operable terminal 20ₙ in order to transmit/receive data, including a search request and/or resultant search results data, and/or display/retrieve (at least) one or more images 12ₙ within a search engine GUI(s) 18ₙ installed on the user operable terminal 20ₙ. User operable terminals 20ₙ may include various types of software and/or hardware (not shown) required for capturing, transmitting, receiving, analysing, processing, conveying and/or displaying data and images 12ₙ to/from network server 24ₙ, source network locations 14ₙ, and external server(s) 30ₙ, via communications network 22ₙ, in accordance with system 10 including, but not limited to: web-browser or other GUI 18ₙ application(s) or App(s) (e.g. one or more search engine GUI's 18ₙ), which could simply be an operating system installed on user terminal 20ₙ that is capable of actively transmitting, receiving, conveying and/or displaying data on a screen without the need of a web-browser GUI, etc.; a plurality of tools or applications (not shown, but which may be, for example, software and/or hardware modules or applications, etc.) that provide a means of identifying, retrieving, analysing and/or processing one or more images 12ₙ (and any desired available associated data, e.g. text-based data associated with an image(s) 12ₙ, as will be described in further detail below), from one or more source network locations 14ₙ, for display within a search engine GUI(s) 18ₙ after search results data is returned by way of, for example, network server 24ₙ; monitor(s) (touch sensitive or otherwise); GUI pointing device(s); keyboard(s); sound capture device(s) (e.g. one or more microphone devices for capturing a user's voice commands, etc.); sound emitting device(s) (e.g. one or more loudspeakers and/or text to speech convertors, etc., for audibly conveying search results data and/or any text-based data associated with image(s) 12ₙ); gesture capture device(s) (e.g. one or more cameras for capturing a user's gesture commands, etc.); augmented reality device(s); smart watch(es); and/or, any other suitable data acquisition, transmission, conveying and/or display device(s) (not shown).

A search request may be captured by a user operable terminal 20ₙ directly by way of, e.g. a user 32ₙ utilising their finger(s), thumb(s), a keyboard, a GUI pointing device(s), etc., or a voice command, physical motion or gesture, etc. Alternatively, a search request may be captured by way of a user 32ₙ utilising a user interface (not shown), e.g. a smart watch, augmented reality device, etc., connected to the user operable terminal 20ₙ. A search request may also not involve any user 32ₙ directed input at all, but instead could be submitted to network server 24ₙ, as desired by a user operable terminal 20ₙ itself, based on algorithms, e.g. predictive algorithms, residing on the user operable terminal(s) 20ₙ, which may determine that a user 32ₙ has an interest in a particular topic or subject matter, by way of, for example, analysing a user's 32ₙ behaviour or their geographical location. Similarly, one or more images 12ₙ (and any desired available associated data), and possibly other search results data associated therewith, may be displayed to a user 32ₙ by way of one or more screens or monitors of a user operable terminal 20ₙ, or may be displayed to the user 32ₙ by way of a user interface (not shown), e.g. a smart watch, augmented reality device, etc., connected to the user operable terminal 20ₙ. It yet a further embodiment, (at least) the one or more images 12ₙ may be displayed to a user 32ₙ by way of one or more screens or monitors of a user operable terminal 20ₙ (or may be displayed to the user 32ₙ by way of a user interface (not shown), e.g. a smart watch, augmented reality device, etc., connected to the user operable terminal 20ₙ), whilst the search results data and/or any text-based data associated with image(s) 12ₙ may be audibly conveyed to the user 32ₙ by way of one or more sound emitting device(s) of (or connected to) the user operable terminal 20ₙ. For example, and as will be described in further detail below, the one or more image(s) 12ₙ retrieved from one or more source network locations 14ₙ, may be displayed (by way of, for example, an augmented reality device(s), etc.) to a user 32ₙ by way of the exemplary search engine GUI 18ₙ of FIG. 10, with the corresponding search results data and/or any desired associated image(s) 12ₙ data being audibly conveyed to the user 32ₙ by way of one or more sound emitting device(s) of (or connected to) the user operable terminal 20ₙ (or augmented reality device(s), etc.). the It will be appreciated that where user interfaces (not shown), such as, for example, a smart watch and/or an augmented reality device, are referred to as being interfaces that may be connected (wired or wirelessly) to a user operable terminal 20ₙ, such interfaces could themselves be a user operable terminal 20ₙ in accordance with the present invention. That is, a device, such as, for example, an augmented reality device (not shown) could be a standalone user operable terminal 20ₙ, or passive display device, suitable for use in accordance with system 10 of the present invention.

Network server 24ₙ is configured to communicate with user operable terminals 20ₙ and external server(s) 30ₙ via any suitable communications connection or network 22ₙ (hereinafter referred to simply as a “network(s) 22ₙ”). External server(s) 30ₙ is/are configured to transmit and receive data to/from network server 24ₙ and user operable terminals 20ₙ, via network(s) 22ₙ. User operable terminals 20ₙ are configured to transmit, receive and/or display data and images 12ₙ from/to network server 24ₙ, source network locations 14ₙ, and external server(s) 30ₙ, via network(s) 22ₙ. Each user operable terminal 20ₙ and external server 30ₙ may communicate with network server 24ₙ (and each other, where applicable) via the same or a different network 22ₙ. Suitable networks 22ₙ include, but are not limited to: a Local Area Network (LAN); a Personal Area Network (PAN), as for example an Intranet; a Wide Area Network (WAN), as for example the Internet; a Virtual Private Network (VPN); a Wireless Application Protocol (WAP) network, or any other suitable telecommunication network, such as, for example, a GSM, 3G, 4G, etc., network; Bluetooth network; and/or any suitable WiFi network (wireless network). Network server 24ₙ, external server(s) 30ₙ, and/or user operable terminal 20ₙ, may include various types of hardware and/or software necessary for communicating with one another via network(s) 22ₙ, and/or additional computers, hardware, software, such as, for example, routers, switches, access points and/or cellular towers, etc. (not shown), each of which would be deemed appropriate by persons skilled in the relevant art.

For security purposes, various levels or security, including hardware and/or software, such as, for example, firewalls, tokens, two-step authentication (not shown), etc., may be used to prevent the unauthorized access to, for example, network server 24ₙ and/or external server(s) 30ₙ. Similarly, network server 24ₙ and/or external server(s) 30ₙ may utilise security (e.g. hardware and/or software—not shown) to validate access by user operable terminals 20ₙ, or when exchanging information between respective servers 24ₙ, 30ₙ. It is also preferred that network server 24ₙ performs validation functions to ensure the integrity of data transmitted between external server(s) 30ₙ and/or user operable terminals 20ₙ. A person skilled in the relevant art will appreciate such technologies and the many options available to achieve a desired level of security and/or data validation, and as such a detailed discussion of same will not be provided. Accordingly, the present invention should be construed as including within its scope any suitable security and/or data validation technologies as would be deemed appropriate by a person skilled in the relevant art.

Communication and/or data transfer between network server 24ₙ, external server(s) 30ₙ and/or user operable terminals 20ₙ, may be achieved utilising any suitable communication, software architectural style, and/or data transfer protocol, such as, for example, FTP, Hypertext Transfer Protocol (HTTP), Representational State Transfer (REST); Simple Object Access Protocol (SOAP); Electronic Mail (hereinafter simply referred to as “e-mail”), Unstructured Supplementary Service Data (USSD), voice, Voice over IP (VoIP), Transfer Control Protocol/Internet Protocol (hereinafter simply referred to as “TCP/IP”), Short Message Service (hereinafter simply referred to as “SMS”), Multimedia Message Service (hereinafter simply referred to as “MMS”), any suitable Internet based message service, any combination of the preceding protocols and/or technologies, and/or any other suitable protocol or communication technology that allows delivery of data and/or communication/data transfer between network server 24ₙ, external server(s) 30ₙ and/or user operable terminals 20ₙ, in accordance with system 10. Similarly, any suitable data transfer or file format may be used in accordance with system 10, including (but not limited to): text; a delimited file format, such as, for example, a CSV (Comma-Separated Values) file format; a RESTful web services format; a JavaScript Object Notation (JSON) data transfer format; a PDF (Portable Document Format) format; and/or, an XML (Extensible Mark-Up Language) file format.

Access to network server 24ₙ and the transfer of information between network server 24ₙ, source network locations 14ₙ, external server(s) 30ₙ and/or user operable terminals 20ₙ, may be intermittently provided (for example, upon request), but is preferably provided “live”, i.e. in real-time.

As already outlined above, system 10 is designed to provide an improved process for identifying, retrieving and processing one or more images 12ₙ (and possibly any desired available associated data, e.g. text-based data associated with an image(s) 12ₙ, as will be described in further detail below) from one or more source network locations 14ₙ for display at one or more predetermined target network locations 16ₙ (preferably within a search results screen or page of a search engine GUI 18ₙ installed on a user operable terminal 20ₙ after a search has been performed). To do this, system 10 provides various novel means for identifying and/or retrieving images 12ₙ (and any desired available associated data) as required, and for analysing and/or processing/manipulating (if necessary) those images 12ₙ for display within a search engine GUI 18ₙ. All of this preferably occurring substantially in real-time.

Again as already briefly outlined above, network server 24ₙ, user operable terminal(s) 20ₙ and/or external server(s) 30ₙ, may host and/or maintain a plurality of applications (not shown, but which may be, for example, software and/or hardware modules or applications, etc.) and database(s)/storage device(s) 28ₙ (although only network server 24ₙ database(s)/storage device(s) 28ₙ are shown, others may be utilised where required) that enable multiple aspects of system 10 to be provided over network(s) 22ₙ. These module(s) or application(s) (not shown) and database(s)/storage device(s) 28ₙ may include, but are not limited to: one or more network server 24ₙ and/or external server(s) 30ₙ based database(s)/storage device(s) 26ₙ for storing (whether temporarily or permanently) and/or indexing web data for the purpose of streamlining the provision of at least text-based search results data (and associated source network locations 14ₙ addresses, e.g. URLs) in response to search requests submitted via user operable terminals 20ₙ; one or more module(s) or application(s) for capturing search requests input via, or generated by, a user operable terminal 20ₙ (or one or more user interfaces connected thereto), for submitting the search request to network server 24ₙ (via network(s) 22ₙ) for processing (which may be achieved by sending the search request to search engine database(s)/storage device(s) 28ₙ either directly, or by of a search engine API, etc.), and for retrieving/receiving the resultant search results data (e.g. at least text-based search results data and the corresponding URLs of the source network locations 14ₙ) after the search have been performed; one or more module(s) or application(s) (such as, for example, web-crawlers, algorithmic commands, or the likes) for scanning source network locations 14ₙ identified in response to a search, and for identifying and retrieving one or more suitable image(s) 12ₙ (and any desired available associated data) from each source network location 14ₙ (as already discussed above, this/these such module(s) or application(s) may reside on network server 24ₙ, user operable terminal(s) 20ₙ and/or external server(s) 30ₙ, as desired, depending on where such processing is to be performed (e.g. server 24ₙ/30ₙ side or user operable terminal 20ₙ side)); one or more module(s) or application(s) for analysing and processing (if necessary) the retrieved images 12ₙ, and for selecting which image or images 12ₙ is/are to be displayed within search engine GUI(s) 18ₙ (as already discussed above, this/these such module(s) or application(s) may reside on network server 24ₙ, user operable terminal(s) 20ₙ and/or external server(s) 30ₙ, as desired, depending on where such processing is to be performed (e.g. server 24ₙ/30ₙ side or user operable terminal 20ₙ side)); one or more module(s) or application(s) for generating or acquiring a thumbnail image(s) 12ₙ and for locating and retrieving source moving image 12ₙ file links (e.g. video file links, such as, for example, YouTube identification strings) in response to moving images 12ₙ being located at source network locations 14ₙ, for the purpose of enabling moving images 12ₙ, or a portion thereof (e.g. a preview of the video file, etc.), to be played within search engine GUI(s) 18ₙ automatically, or as desired by a user 32ₙ (this/these such module(s) or application(s) may reside on network server 24ₙ, user operable terminal(s) 20ₙ and/or external server(s) 30ₙ, as desired, depending on where such processing is to be performed (e.g. server 24ₙ/30ₙ side or user operable terminal 20ₙ side)); one or more module(s) or application(s) and database(s) or storage device(s) (e.g. 28ₙ) for generating and/or storing (whether temporarily or permanently) image(s) 12ₙ for use in situations where it is determined that no suitable image(s) 12ₙ is/are available at a source network location 14ₙ, and/or for storing (whether temporarily or permanently) retrieved and/or processed image(s) 12ₙ (and any associated data) for future use (this/these such module(s), application(s), database(s) and/or storage device(s) may reside on network server 24ₙ, user operable terminal(s) 20ₙ and/or external server(s) 30ₙ, as desired, depending on where such processing is to be performed (e.g. server 24ₙ/30ₙ side or user operable terminal 20ₙ side)); and/or, one or more user operable terminal 20ₙ based module(s) or application(s) for generating and displaying the selected image(s) 12ₙ within search engine GUI(s) 18ₙ, along with any desired or required associated data (e.g. text-based search results data, URLs, and/or associated data retrieved along with the image(s) 12ₙ, etc.) after a search has been performed (the image(s) 12ₙ and any associated data preferably being presented in the form of an activatable tile or region 38ₙ that when selected or otherwise activated links through to the respective source network location 14ₙ).

Although separate modules, applications or engines (not shown) and database(s)/storage device(s) (e.g. 28ₙ) have been outlined (each with reference to one or more of network server 24ₙ, external server(s) 30ₙ and user operable terminal(s) 20ₙ), each for effecting specific preferred aspects (or combinations thereof) of system 10, it should be appreciated that any number of modules/applications/engines/databases/storage devices for performing any one, or any suitable combination of, aspects of system 10, could be provided (wherever required) in accordance with the present invention. A person skilled in the relevant art will appreciate many such module(s)/application(s)/engine(s) and database(s)/storage device(s) embodiments, modifications, variations and alternatives therefor, and as such the present invention should not be construed as limited to any of the examples provided herein and/or described with reference to the drawings.

In order to provide a more detailed understanding of the operation of preferred system 10 of the present invention, reference will now be made to the exemplary GUI's 18ₙ (e.g. search engine GUI(s) 18ₙ, as shown) shown in FIGS. 2 & 7 to 10, which illustrate preferred constructions of various screens or pages 18ₙ that may be presented to a user 32ₙ after a search has been performed in accordance with system 10 as herein described. Although exemplary GUI's 18ₙ are shown and described with reference to FIGS. 2 & 7 to 10, it will be appreciated that any suitable GUI(s) 18ₙ may be used depending on the application of system 10 (e.g. for search engine applications or otherwise, etc.), and the way in which GUI(s) 18ₙ of system 10 are accessible via, for example, network(s) 22ₙ, to user(s) 32ₙ, via user operable terminals 20ₙ. Similarly, the content of GUI's 18ₙ shown in FIGS. 2 & 7 to 10 only represents an example of the type of information that may be displayed to user(s) 32ₙ of system 10. Accordingly, the present invention should not be construed as being limited to any or more of the specific GUI 18ₙ examples provided.

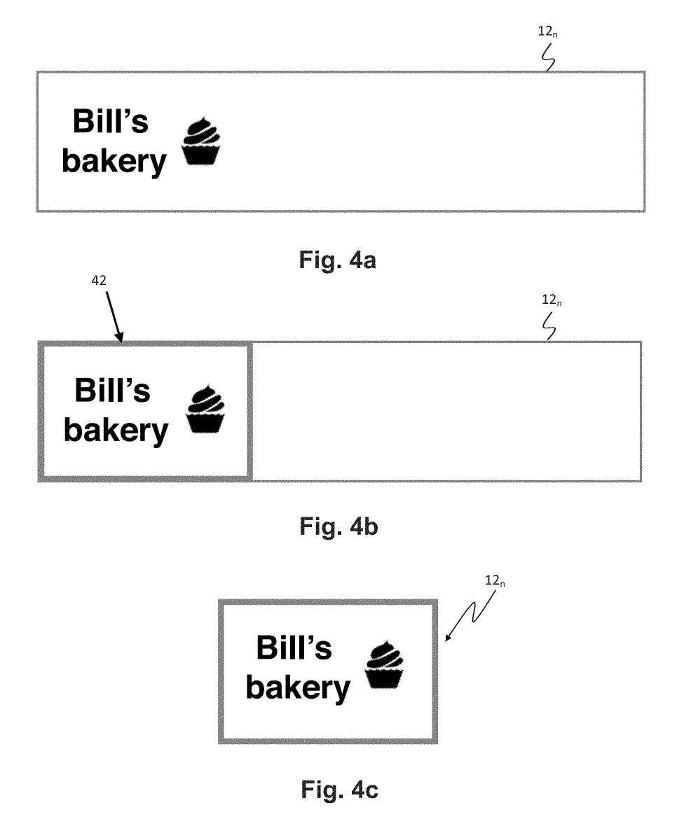

Preferred search engine GUI's 18ₙ of FIGS. 2 & 7 to 10 will be described in conjunction with the flow diagrams of FIGS. 3a & 3b (each of which illustrate a preferred image processing method 100/200 suitable for use with image processing system 10 of FIG. 1) and the exemplary image 12ₙ diagrams of FIGS. 4a to 6b (each of which illustrate, in steps, preferred ways in which image(s) 12ₙ may be manipulated/processed (if necessary) for display within search engine GUI(s) 18ₙ in accordance with the preferred image processing system 10 and/or methods 100/200 shown in FIGS. 1, 3a & 3b). Although preferred image 12ₙ processing methods 100, 200, and associated preferred techniques for manipulating/processing images 12ₙ, will be described with reference to the flow diagrams of FIGS. 3a & 3b, and the image 12ₙ diagrams of FIGS. 4a to 6b, it is to be understood that these diagrams only illustrate examples of the way in which images 12ₙ may be identified, retrieved, manipulated and/or processed in accordance with system 10. Many other methods (not shown) may be utilised to achieve the same or similar result and as such the present invention should not be construed as limited to the specific examples provided. Further, it will be appreciated by a skilled person that not all method steps are recited herein, and/or that some method steps that are recited herein are not essential to the operation of methods 100, 200, and the associated techniques for manipulating/processing images 12ₙ described with reference to FIGS. 4a to 6b. Various steps that are not recited, or which may be readily omitted, will be readily apparent to a skilled person and thus need not be described in detail herein.

In FIG. 2 there is shown an exemplary search engine GUI 18ₙ which illustrates a preferred way in which one or more images 12ₙ (retrieved from one or more source network location(s) 14ₙ) may be processed and displayed alongside associated text-based data 34ₙ (e.g. search results data 34ₙ and/or associated data 34ₙ retrieved along with the image(s) 12ₙ) after a search has been performed. Aside from the one or more images 12ₙ, and their associated text-based data 34ₙ, as can be seen in FIG. 2, alongside each search result displayed within search engine GUI 18ₙ there may also be displayed details of the respective source network location 14ₙ, such as, for example, the address or URL 36ₙ of each source network location 14ₙ, as shown. As already outlined above, the selected content shown in FIG. 2, i.e. the image(s) 12ₙ, text-based search results or associated data 34ₙ and source network location 14ₙ address or URL details 36ₙ, provided within each search engine GUI 18ₙ may be generated for display by way of the one or more user operable terminal 20ₙ based module(s) or application(s) (not shown) for generating and displaying the selected image(s) 12ₙ (along with any desired or required associated data 34ₙ, 36ₙ) within search engine GUI(s) 18ₙ.

As can be seen in FIG. 2, it is preferred that for each search result displayed within search engine GUI 18ₙ, the respective image(s) 12ₙ (in this embodiment, a single image 12ₙ for each search result), text-based search results or associated data 34ₙ and source network location 14ₙ address or URL 36ₙ, are presented in the form of an activatable tile or region 38ₙ that when selected or activated (automatically, or by, for example, a finger, GUI pointing device, voice command, gesture, etc.—whether input/captured directly by a user operable terminal 20ₙ or input/captured by an user interface (not shown) connected to a user operable terminal 20ₙ) links through to the respective source network location 14ₙ. That is, upon selecting or otherwise activating a tile or region 38ₙ (for a particular search result) within search engine GUI 18ₙ, a user 32ₙ is readily able to navigate to the respective source network location 14ₙ (corresponding to the particular selected search result) so as to be able to view all/desired network content available at that source network location 14ₙ.

A flow diagram illustrating a first preferred image processing method 100 is shown in FIG. 3a. In this first preferred image processing method 100, the image 12ₙ identification, retrieval and processing steps may be performed by/at a user operable terminal(s) 20ₙ. That is, network server 24ₙ and external server(s) 30ₙ, need only provide (at least) text-based search results data 34ₙ along with details of the associated source network locations 14ₙ (e.g. addresses or URLs 36ₙ of each source network location 14ₙ) in response to a search request input at, or generated by, a user operable terminal 20ₙ. Hence, the one or more module(s), application(s), database(s) or storage device(s) for: scanning/perusing source network locations 14ₙ identified in response to a search, and for identifying and retrieving one or more suitable image(s) 12ₙ (and any desired available associated data 34ₙ) from each source network location 14ₙ; analysing and processing (if necessary) the retrieved images 12ₙ (and any associated data 34ₙ), and for selecting which image or images 12ₙ is/are to be displayed within search engine GUI(s) 18ₙ; generating or acquiring a thumbnail image(s) 12ₙ and for locating and retrieving source moving image 12ₙ file links in response to moving images 12ₙ being located at source network locations 14ₙ, for the purpose of enabling moving images 12ₙ, or a portion thereof (e.g. a preview) to be played within search engine GUI(s) 18ₙ automatically, or as desired by a user 32ₙ; and/or, generating and/or storing (whether temporarily or permanently) image(s) 12ₙ for use in situations where it is determined that no suitable image(s) 12ₙ is/are available at a source network location 14ₙ, and/or for storing (whether temporarily or permanently) retrieved and/or processed image(s) 12ₙ (and any associated data 34ₙ) for future use; may each reside on user operable terminal(s) 20ₙ.

As can be seen in FIG. 3a, preferred image processing method 100 commences at step 102 whereat a search query or request (whether input or otherwise captured by/from a user 32ₙ of a user operable terminal 20ₙ, or generated by the user operable terminal 20ₙ itself by way of, for example, predictive algorithms, etc.) is transferred from user operable terminal 20ₙ to one or more search engine database(s)/storage device(s) (either directly, or by of one or more search engine API(s), etc.) of network server 24ₙ and/or external server(s) 30ₙ, via network(s) 22ₙ. The search query may be, for example, a key-word based query, an image based query, an object based query (e.g. a query based on an object visible via, for example, an augmented reality device, etc.), a tag based query (e.g. a request to search for source network location(s) 14ₙ containing image(s) 12ₙ sharing the same or similar tags or tag names, etc., including a geotag based query, e.g. a query based on the geographical data embedded within the image, i.e. the time and geographical location that an image(s) 12ₙ, such as a photograph 12ₙ, was taken, etc.), and/or a bookmark folder contents or folder name based query (e.g. should a user 32ₙ wish to import a bulk list of URLs 36ₙ from, for example, an external bookmark service or database (not shown), at step 104, preferred method 100 may retrieve image(s) 12ₙ for each of URLs 36ₙ simultaneously). A search is then performed (in response to the search query—the search may be based on indexed data, e.g. such as that stored in search engine database(s) 28ₙ, and/or may be a real-time search performed on non-indexed or live data, etc.), and thereafter, at step 104, at least text-based search results data 34ₙ and details of a plurality of source network locations 14ₙ (e.g. the network addresses or URLs 36ₙ, etc., of the source network locations 14ₙ) related thereto are returned to the user operable terminal 20ₙ. As already outlined above, the capture of the search query, transmission thereof, and retrieval of the search results data 34ₙ, 36ₙ in response to the search query, may be facilitated by way of the one or more module(s) or application(s) (not shown) for capturing search requests input via, or generated by, a user operable terminal 20ₙ (or one or more user interfaces connected thereto), for submitting the search request to server 24ₙ, 30ₙ (via network(s) 22ₙ) for processing, and for retrieving/receiving the resultant search results data after the search have been performed.

Upon user operable terminal 20ₙ receiving the search results data 34ₙ, 36ₙ, in response to the search request (either upon receiving all search results data 34ₙ, 36ₙ, or upon receiving some of the search results data 34ₙ, 36ₙ, i.e. commencing immediately upon receiving some of the data and continuing simultaneously whilst the remaining data is being retrieved), method 100 may continue at step 106, whereat user operable terminal 20ₙ then sends web-crawlers (not shown), algorithmic commands (not shown) or the likes, to each of the source network locations 14ₙ (i.e. network addresses or URLs 36ₙ, etc.) that were identified as part of the search in an attempt to identify and retrieve one or more suitable image(s) 12ₙ (and/or any desired available associated data 34ₙ—as will be described in further detail below) from each source network location 14ₙ. Thereafter, at step 108, it is checked whether or not one or more suitable image(s) 12ₙ (and/or any desired associated data 34ₙ) is/are available at each source network location 14ₙ.

Preferred processes/techniques for identifying one or more suitable image(s) 12ₙ (and/or any desired available associated data 34ₙ) at each source network location 14ₙ (in accordance with, e.g., steps 106 & 108, of preferred method 100) may include, but are not limited to: utilising advanced data mining, deep learning, machine learning and/or artificial intelligence processes as part of the scanning/crawling of source network location(s) 14ₙ so as to make informed decisions about the existence and suitability of any image(s) 12ₙ (and/or associated data 34ₙ) available at the source network location(s) 14ₙ; mining Hyper Text Markup Language (HTML), Javascript, Cascading Style Sheets (CSS), embedded link data (such as, for example, YouTube embedded link data), or other types of code available at source network location(s) 14ₙ, to determine the size and order of image(s) 12ₙ on that/those source network location(s) 14ₙ, and utilising the acquired data to make decisions about the most appropriate or suitable image(s) 12ₙ available at the source network location(s) 14ₙ; utilising individual or aggregated user 32ₙ data (e.g. user's 32ₙ browsing history or preferences and/or settings configured at an account or user operable terminal(s) 20ₙ level, etc.) to make determinations about the most appropriate image(s) 12ₙ suitable for display for an individual user 32ₙ, or sub group of user's 32ₙ, etc. (for example, if it is known that a particular user 32ₙ has historically or recently been searching for information related to ‘small cars’ and an automotive related source network location(s) 14ₙ is retrieved in response to a search query, system 10 or method 100 may favour the display or ‘small car’ image(s) 12ₙ over ‘large car’ image(s) 12ₙ from the/those source network locations(s) 14ₙ—thus tailoring the display of image(s) 12ₙ to suit the predicted needs of user's 32ₙ, etc.); ignoring image(s) 12ₙ of unusual shape or size, such as, for example, image(s) 12ₙ smaller than a certain pixel height of width, very thin image(s) 12ₙ, or very long image(s) 12ₙ that may not be readily or effectively displayed within the predetermined image 12ₙ display area(s) provided within search engine GUI(s) 18ₙ; recognising advertisement(s) and/or third party embedded logo(s) (e.g. PayPal, VISA, AMEX, or other payment, security, web designer third party logo(s), etc.) at source network location(s) 14ₙ and ignoring the image(s) 12ₙ associated with the/those advertisement(s)/third party logo(s) in favour of the display of other image(s) 12ₙ (if any) available at the source network location(s) 14ₙ; utilising image 12ₙ tagging protocols, such as, for example, commonly accepted tagging profiles like Facebook's Open Graph Mark-Up protocol, or Twitter's tagging protocol, or other known or proprietary protocols, to determine the existence and suitability of any image(s) 12ₙ available at the source network location(s) 14ₙ; scanning or analysing available image(s) 12ₙ metadata to determine the suitability of image(s) 12ₙ (and/or associated data 34ₙ) available at source network location(s) 14ₙ (should such metadata not be available, then large image(s) 12ₙ, or moving image(s) 12ₙ, etc., may be favoured over other image(s) 12ₙ available at a source network location(s) 14ₙ); and/or, utilising real time image(s) 12ₙ processing to compare the characteristics of available/retrieved image(s) 12ₙ to that of the characteristics of offensive image(s) 12ₙ and selectivity excluding image(s) 12ₙ from display that may be likely to be offensive to user's 32ₙ (e.g. determining and ignoring image(s) 12ₙ which include nudity, pornography and/or violent elements, themes, etc.—the exclusion of such image(s) 12ₙ could be determined based on settings associated with a user 32ₙ, or user operable terminal(s) 20ₙ, e.g. based on parental controls, etc.). A skilled person will appreciate such preferred methods/techniques for identifying suitable image(s) 12ₙ, (and/or any desired associated data 34ₙ) available at source network location(s) 14ₙ, along with alternatives, variations or modifications thereof, and as such, the present invention should not be construed as limited to any one or more of the specific examples provided herein.

If at step 108 it is determined that one or more suitable image(s) 12ₙ (and/or any desired associated data 34ₙ) are available at a/some/all source network location(s) 14ₙ, then preferred method 100 continues at step 110, whereat the one or more suitable image(s) 12ₙ (and/or associated data 34ₙ) are retrieved (by user operable terminal 20ₙ) from the/some/all source network location(s) 14ₙ, before being analysed and processed (if necessary) at step 112 (described below). Although not specifically shown in FIG. 3a, if desired, before and/or after retrieving one or more suitable image(s) 12ₙ at steps 110, 112, each (or at least selected ones) image(s) 12ₙ may be reduced in size (i.e. to a predetermined low pixel count, etc.) so as to reduce computational overhead or bandwidth usage, etc. For example, by lowering the pixel count of an image(s) 12ₙ prior to retrieving same, at step 110, the computational overhead and bandwidth required to download each pixel of that/those image(s) 12ₙ is reduced, thus improving the speed of download of image(s) 12ₙ and ultimately improving the operation of system 10 and/or the operating costs associated therewith.

Alternatively, if at step 108 it is determined that one or more suitable image(s) 12ₙ are not available at a/some/all network location(s) 14ₙ, then preferred method 100 continues at step 114, whereat no image(s) 12ₙ are retrieved from the/some/all source network location(s) 14ₙ, and instead, at step 116, a predetermined image(s) 12ₙ is/are loaded and/or generated by user operable terminal 20ₙ for display within search engine GUI(s) 18ₙ. It will be appreciated that steps 106, 108, 110 & 114, of preferred method 100 of FIG. 3a, may be facilitated by way of the one or more module(s) or application(s) (not shown) for scanning source network locations 14ₙ identified in response to a search, and for identifying and retrieving one or more suitable image(s) 12ₙ (and any desired available associated data 34ₙ) from each source network location 14ₙ, as already outlined above.

If one or more image(s) 12ₙ (and/or any desired associated data 34ₙ) are retrieved from a/some/all source network location(s) 14ₙ at step 110, the/those image(s) 12ₙ (and/or associated data 34ₙ) are then analysed and processed (if necessary) by/at the user operable terminal 20ₙ (at step 112), before the most suitable/appropriate image(s) 12ₙ (and/or associated data 34ₙ) are selected for display (and/or are selected to be audibly conveyed along with the display of image(s) 12ₙ, in the case of any text-based search results or associated data 34ₙ, etc.) within search engine GUI(s) 18ₙ (again, at step 112). Preferred methods/techniques of/for analysing, processing and/or selecting suitable image(s) 12ₙ for display within search engine GUI(s) 18ₙ, each of which are suitable for use with step 112, of preferred method 100, will be described in further detail below (including with reference to the image 12ₙ diagrams of FIGS. 4a to 6b). Although preferred embodiments of methods/techniques for analysing, processing and/or selecting suitable image(s) 12ₙ for display within search engine GUI(s) 18ₙ will be provided in detail below, the present invention should not be construed as limited to those examples alone. A person skilled in the art will appreciate these and other suitable methods/techniques, modifications and/or variations thereof, and as such the present invention should be construed as including within its scope any suitable methods/techniques for analysing, processing and/or selecting suitable image(s) 12ₙ for display within search engine GUI(s) 18ₙ, at step 112, of preferred method 100. Further, and as already outlined above, it will be appreciated that one or more of the processes of step 112 may be facilitated by way of the one or more module(s) or application(s) (not shown) for analysing and processing (if necessary) the retrieved images 12ₙ, and for selecting which image or images 12ₙ is/are to be displayed within search engine GUI(s) 18ₙ.

If, at step 108, it is determined that one or more moving image(s) 12ₙ (e.g. videos or movies 12ₙ) are available at a/some/all source network location(s) 14ₙ, then the one or more module(s) or application(s) (not shown—but as already outlined above) for generating or acquiring a thumbnail image(s) 12ₙ, and for locating and retrieving source moving image 12ₙ file links (e.g. video file links, such as, for example, YouTube identification strings) for the purpose of enabling the/each moving image(s) 12ₙ, or a portion thereof (e.g. a preview of the video file 12ₙ, etc.), to be played (whether selectively or automatically) within a search engine GUI(s) 18ₙ may be utilised at steps 110 and 112. The process of identifying and processing (at steps 108 to 112), for example, embedded video(s) 12ₙ (e.g. embedded YouTube video(s) 12ₙ, etc.) within a source network location 14ₙ may involve, but is not limited to: scanning the network location 14ₙ for the presence of embedded video links; acquiring the identification sting or source location details for each link; generating a thumbnail or any other suitable image 12ₙ of the/each video file 12ₙ; overlaying an icon (e.g. a play symbol, etc.) on each thumbnail or other suitable image 12ₙ that was generated so as to inform a user 32ₙ that the respective source network location 14ₙ contains moving image 12ₙ content, as opposed to just still image(s) 12ₙ; and, using the acquired identification string(s) to enable the/each video 12ₙ and/or a portion thereof (e.g. a preview of the video 12ₙ) to be selectively or automatically played within search engine GUI(s) 18ₙ (this may be achieved by, for example, connecting to a third party video API(s), not shown, but which may be provided by an external server(s) 30ₙ, such as, for example, a YouTube API, and accessing and streaming the video 12ₙ directly from the YouTube API to the search engine GUI(s) 18ₙ by matching the acquired video identification string found within the/each source network location(s) 14ₙ to the same video 12ₙ, etc., stored on YouTube, etc.). By enabling at least a preview of a moving image(s) 12ₙ to be played within search engine GUI(s) 18ₙ, a user 32ₙ may readily watch/preview the moving image(s) 12ₙ without having to navigate to the actual source network location(s) 14ₙ to determine whether the image 12ₙ or site 14ₙ content is of interest to them.

Referring back to step 108, if it is determined that no suitable image(s) 12ₙ are available at a/some/all network location(s) 14ₙ, then preferred method 100 continues at steps 114 & 116 as described previously. That is, no image(s) 12ₙ are retrieved from the/some/all source network location(s) 14ₙ (at step 114), and instead, at least one predetermined image(s) 12ₙ for each source network location 14ₙ is/are loaded and/or generated by user operable terminal 20ₙ for display within search engine GUI(s) 18ₙ (at step 116). It will be appreciated that step 116, of preferred method 100 of FIG. 3a, may be facilitated by way of the one or more module(s) or application(s) and database(s) or storage device(s) (not shown) for generating and/or storing (whether temporarily or permanently) image(s) 12ₙ for use in situations where it is determined that no suitable image(s) 12ₙ is/are available at a source network location 14ₙ, and/or for storing (whether temporarily or permanently) retrieved and/or processed image(s) 12ₙ (and any desired associated data 34ₙ) for future use, as already outlined above. Preferred process(es) for selecting (e.g. loading and/or generating at step 116) predetermined image(s) 12ₙ for use in situations where no image(s) 12ₙ are identified and retrieved from source network location(s) 14ₙ may include, but are not limited to: recording and compiling (either periodically, or in real-time as required) a list of source network location(s) 14ₙ for which image(s) 12ₙ cannot be retrieved, and then applying automated processes to generate, or source from a third party (e.g. external server(s) 30ₙ, etc.), screenshots (e.g. image(s) 12ₙ) of one or more regions or pages (e.g. web-page(s) 14ₙ) of the source network location(s) 14ₙ (e.g. website(s) 14ₙ); and, then making those screenshots 12ₙ available for display within search engine GUI(s) 18ₙ for use at step 116, of preferred method 100, shown in FIG. 3a. Instead of generating and acquiring screenshot(s) 12ₙ, of source network location(s) 14ₙ, the address(es) or URL(s) 36ₙ of the source network location(s) 14ₙ may be overlaid on a contrasting predetermined coloured background for use as image(s) 12ₙ (at step 116) in situations where no image(s) 12ₙ is/are identified and/or retrieved at steps 108 & 114. Although preferred examples of the way in which predetermined image(s) 12ₙ may be generated and/or loaded at step 116, for use in situations where no image(s) 12ₙ (or at least no suitable image(s) 12ₙ) is/are identified and/or retrieved at steps 108 & 114, are provided herein, it should be appreciated that the present invention is not limited to just those examples. Instead, the present invention should be construed as including within its scope any suitable method(s)/means of generating and/or loading predetermined image(s) 12ₙ for use in accordance with step 116, of preferred method 100, shown in FIG. 3a.

Although not specifically shown in FIG. 3a, after one or more image(s) 12ₙ (and/or any desired available associated data 34ₙ) for each source network location(s) 14ₙ are selected (or loaded/generated) for display within search engine GUI(s) 18ₙ at either or steps 112 or 116, the selected image(s) 12ₙ (and/or specific details pertaining thereto, such as, for example, the number, size, aspect ratio, pixel dimensions, image 12ₙ file name(s) and/or proprietary system 10 data generated after image(s) 12ₙ have been processed, including the most appropriate portion of particular image(s) 12ₙ to display, etc.) may be stored (along with any associated data 34ₙ) in one or more database(s) and/or storage device(s) associated with one or more of user operable terminal(s) 20ₙ, network server 24 and/or external server(s) 30ₙ, for future use. Storage (whether temporarily or permanently) of image(s) 12ₙ (and any desired associated data 34ₙ) and/or details pertaining thereto may improve the future selection and processing of image(s) 12ₙ (and/or associated data 34ₙ) for the same or different source network location(s) 14ₙ. It will be appreciated that the storage (whether temporarily or permanently) of image(s) 12ₙ (and/or associated data 34ₙ, and/or specific details pertaining thereto) may be facilitated by way of the one or more module(s) or application(s) and database(s) or storage device(s) (not shown) for generating and/or storing image(s) 12ₙ for use in situations where it is determined that no suitable image(s) 12ₙ is/are available at a source network location 14ₙ, and/or for storing retrieved and/or processed image(s) 12ₙ (and any associated data 34ₙ) for future us, as already outlined above. If the use of such module(s), application(s), database(s) or storage device(s) (not shown) is provided in accordance with preferred method 100, of FIG. 3a, then referring back to 108, if it is determined that a particular source network location(s) 14ₙ has/have been previously (or at least recently) perused/crawled for the purpose of identifying and retrieving image(s) 12ₙ (and/or any desired associated data 34ₙ) for display within search engine GUI(s) 18ₙ, steps 110, 112 and steps 114, 116, may be skipped, and instead the previously stored image(s) 12ₙ (and/or associated data 34ₙ) may be retrieved from the one or more database(s) or storage device(s) (not shown) for further processing at step 118 (described below). Alternatively, steps 110, 112 and steps 114, 116, may be maintained, in part, or in full, e.g. with the respective source network location(s) 14ₙ and/or image(s) 12ₙ (and/or associated data 34ₙ) available thereat, only being, for example, analysed for changes since the respective network location(s) 14ₙ was last perused/crawled, etc.

Again, although not specifically shown in FIG. 3a, the selection and storage or image(s) 12ₙ (and/or associated data 34ₙ, and/or details pertaining thereto), associated with one or more source network location(s) 14ₙ, may be user 32ₙ dependent, and hence, the image(s) 12ₙ, associated data 34ₙ, etc., stored (whether temporarily or permanently) for a particular user 32ₙ (e.g. on their own user operable terminal(s) 20ₙ, or on one or more of server(s) 24ₙ, 30ₙ) may only be applicable to, or accessible by, that user 32ₙ for future processing, unless that user 32ₙ elects to, for example, allow network server 24ₙ, external server(s) 30ₙ and/or other user's 32ₙ to use their personal previously retrieved image(s) 12ₙ (and/or associated data 34ₙ, and/or details pertaining thereto) for future processing. If user 32ₙ dependent selection and/or storage of image(s) 12ₙ, associated data 34ₙ, etc., is desired in accordance with preferred system 10 and/or method 100 of FIGS. 1 & 3a, then user's 32ₙ may be provided with an account for use with system 10. Similarly, image(s) 12ₙ (and/or associated data 34ₙ) may be selected and stored (whether temporarily or permanently) for future use as part of a user's 32ₙ personal book marking facility or service (not shown). A skilled person will appreciate these and other ways in which image(s) 12ₙ (and/or associated data 34ₙ, and/or details pertaining thereto) may be selected and stored (whether temporarily or permanently) to streamline future processing in accordance with preferred method 100 of the present invention. Accordingly, the present invention should not be construed as limited to the specific examples provided herein.

Regardless of the way in which the image(s) 12ₙ (and/or any associated data 34ₙ) are selected (and possibly temporarily or permanently stored for future use, as described previously) for display within (and/or to be audibly conveyed along with) search engine GUI(s) 18ₙ, at either or steps 112 or 116, method 100 then continues at steps 118 & 120, whereat the one or more user operable terminal 20ₙ based module(s) or application(s) (not shown) for generating and displaying the selected image(s) 12ₙ (and any desired associated data 34ₙ, 36ₙ, etc.) within search engine GUI(s) 18ₙ, may be used: to generate the display of the combined image(s) 12ₙ, and any desired search results and/or associated data 34ₙ, 36ₙ (if required—see, for example, FIG. 10, which illustrates an exemplary search engine GUI 18ₙ which only displays image(s) 12ₙ and limited corresponding search results data 36ₙ—as will be described in further detail below), at step 118; and, to generate the activatable tile(s) or region(s) 38ₙ which each link through to their respective source network location 14ₙ, at step 120. Thereafter, preferred method 100 may continue at step 122, whereat if a user 32ₙ selects or otherwise activates (automatically, or by way of, for example, a finger, GUI pointing device, voice command, gesture, etc.—whether input/captured directly by a user operable terminal 20ₙ or input/captured by a user interface (not shown) connected to a user operable terminal 20ₙ) a selected one of the activatable tile(s) or region(s) 38ₙ, the user 32ₙ is navigated to (i.e. linked through to) the respective source network location 14ₙ, whereat they can readily view all/desired network content available at that source network location 14ₙ. The display of the network content available at that source network location 14ₙ may be displayed within the same or a different GUI(s) 18ₙ. For example, and in accordance with a further preferred aspect of the present invention (such as that illustrated by way of the exemplary search engine GUI 18ₙ shown in FIG. 7), the display of the network content available at a selected source network location 14ₙ may be displayed adjacent to (and hence, simultaneously with) the search results data (e.g. the activatable tile(s) or region(s) 38ₙ, and their respective image(s) 12ₙ and associated search results and/or associated data 34ₙ, 36ₙ, if any) which may be displayed in a region, frame or sidebar 40ₙ, or the likes (see, for example, FIG. 7), within search engine GUI(s) 18ₙ, so that the search results data 12ₙ, 34ₙ, 36ₙ, 38ₙ, remain accessible to a user 32ₙ should they wish to access and view the network content associated with a different search result 12ₙ, 34ₙ, 36ₙ, 38ₙ. After navigating through to one or more selected source network location(s) 14ₙ, by way of one or more activatable tile(s) or region(s) 38ₙ, and viewing the required network content available at the selected source network location(s) 14ₙ, method 100 may conclude or end as shown in FIG. 3a.

As already briefly outlined above, and as is shown in FIG. 3a, in accordance with a further preferred aspect of the present invention, as part of the process(es) (of steps 106 to 112) of identifying suitable image(s) 12ₙ for display within search engine GUI(s) 18ₙ, one or more image(s) 12ₙ available at source network location(s) 14ₙ may be analysed to determine whether the/those image(s) 12ₙ have any metadata embedded therein that may be extracted for display (and/or to be audibly conveyed, etc.) in text-form (e.g. as associated data 34ₙ) as part of the display of search results data (alongside the image(s) 12ₙ) within activatable tile(s) or region(s) 38ₙ. For example, should one or more image(s) 12ₙ available at a source network location(s) 14ₙ include metadata that identifies or describes the image(s) 12ₙ content, or the image(s) 12ₙ geographical location, etc., then that metadata (or associated data 34ₙ) is preferably retrieved/extracted (at any of steps 106 to 112, of preferred method 100), for display in text-form alongside the image or image(s) 12ₙ (and other corresponding search results data 34ₙ, 36ₙ) associated with the respective activatable tile(s) or region(s) 38ₙ. It will be appreciated that such associated data 34ₙ (i.e. data associated with one or more image(s) 12ₙ available at a source network location(s) 14ₙ) may be retrieved from a source network location(s) 14ₙ along with, or without, the actual associated image or images 12ₙ being retrieved. That is, even in instances where no image(s) 12ₙ are retrieved from a source network location(s) 14ₙ, any desired associated image data 34ₙ may still be retrieved for display within (and/or to be audibly conveyed along with) the respective activatable tile(s) or region(s) 38ₙ (such as, for example, beside a predetermined image(s) 12ₙ selected/generated at steps 114, 116). Similarly, and in accordance with yet a further preferred aspect of the present invention, any desired data/text 34ₙ (e.g. a header, footer or caption, etc.) that is associated with an image(s) 12ₙ at its source network location 14ₙ, may be retrieved/extracted along with, or without, the image(s) 12ₙ (at, e.g. any of steps 106 to 112) so that that associated data/text 34ₙ may be displayed in text-form within (and/or may be audibly conveyed along with) the respective activatable tile(s) or region(s) 38ₙ. Similarly, and again in accordance with yet a further preferred aspect of the present invention, any desired data/text 34ₙ that is contained within metadata of modules, fields, graphic tiles, blocks or regions at a source network location 14ₙ, may be retrieved/extracted along with, or without, the image(s) 12ₙ (at, e.g. any of steps 106 to 112) so that that data/text 34ₙ may be displayed in text-form within (and/or may be audibly conveyed along with) the respective activatable tile(s) or region(s) 38ₙ.

A flow diagram illustrating a second preferred image processing method 200 is shown in FIG. 3b. In this second preferred image processing method 200, the image 12ₙ identification, retrieval and processing steps may be performed by/at network server 24 and/or external server(s) 30ₙ. That is, network server 24 and/or external server(s) 30ₙ, this time provide both the text-based search results data 34 (along with details of the associated source network locations 14ₙ, e.g. addresses or URLs 36ₙ of each source network location 14ₙ) in response to a search request input at, or generated by, a user operable terminal 20ₙ, and the image 12ₙ identification, retrieval and processing steps required to perform the invention. Hence, the one or more module(s), application(s), database(s) or storage device(s) for: scanning source network locations 14ₙ identified in response to a search, and for identifying and retrieving one or more suitable image(s) 12ₙ (and any desired available associated data 34ₙ) from each source network location 14ₙ; analysing and processing (if necessary) the retrieved images 12ₙ (and any associated data 34ₙ), and for selecting which image or images 12ₙ is/are to be displayed within search engine GUI(s) 18ₙ; generating or acquiring a thumbnail image(s) 12ₙ and for locating and retrieving source moving image 12ₙ file links in response to moving images 12ₙ being located at source network locations 14ₙ, for the purpose of enabling moving images 12ₙ, or a portion thereof (e.g. a preview) to be played within search engine GUI(s) 18ₙ automatically, or as desired by a user 32ₙ; and/or, generating and/or storing (whether temporarily or permanently) image(s) 12ₙ for use in situations where it is determined that no suitable image(s) 12ₙ is/are available at a source network location 14ₙ, and/or for storing (whether temporarily or permanently) retrieved and/or processed image(s) 12ₙ (and any associated data 34ₙ) for future use; may each reside on one or more of network server 24ₙ and/or external server(s) 30ₙ.

As can be seen from a comparison of the flow diagrams of FIGS. 3a & 3b, a number of the steps of preferred method 200 of FIG. 3b, mirror that of the corresponding steps of preferred method 100 of FIG. 3a. That is, step 202 of method 200, along with steps 218 to 222, are essentially the same as that of step 102 and steps 118 to 122, respectively, of method 100. The remaining steps of preferred method 200 only varying to that of the corresponding steps of preferred method 100 in terms of the device(s) that are initiating and/or performing the various procedural tasks. That is, and as already outlined above, instead of those tasks being performed at/by user operable terminal(s) 20ₙ, as in the case of preferred method 100 of FIG. 3a, those tasks are this time preferably being performed at/by network server 24ₙ and/or external server(s) 30ₙ, in the case of method 200 of FIG. 3b. Given the substantial overlap in the two flow diagrams of FIGS. 3a & 3b, a detailed discussion of each step of preferred method 200 need not be provided herein. Instead, referring to FIG. 3b, it can be seen that after a search query or request is sent to the applicable server(s) 24ₙ, 30ₙ, at step 202, preferred method 200 continues at step 204, whereat after the required search has then performed (by, e.g. network server 24ₙ), the text-based search results data 34ₙ and details of the plurality of source network locations 14ₙ (e.g. the network addresses or URLs 36ₙ) related the thereto are returned to both the server(s) 24ₙ, 30ₙ, and the user operable terminal 20ₙ (either directly to user operable terminal(s) 20ₙ, or by being forwarded to the user operable terminal(s) 20ₙ by one of the server(s) 24ₙ, 30ₙ). Thereafter, at steps 206 to 214, one or more of network server 24ₙ and/or external server(s) 30ₙ, performs each (or at least the ones specifically shown in the drawings) of the procedural steps of method 200 that were described above with reference to corresponding steps 106 to 114 of preferred method 100, of FIG. 3a. In addition, for step 212, of preferred method 200, after the retrieved image(s) 12ₙ (and/or any associated data 34ₙ) are analysed and processed (if necessary), and the most appropriate image(s) 12ₙ (and/or associated 34ₙ) for display in connection with each source network location 14ₙ is/are selected, the selected image(s) 12ₙ (and/or associated data 34ₙ) are sent to the user operable terminal(s) 20ₙ to be displayed within (and/or to be audibly conveyed along with) search engine GUI(s) 18ₙ in accordance with steps 218 to 222. Similarly, at step 216, of preferred method 200, a predetermined image(s) 12ₙ for display within search engine GUI(s) 18ₙ in instances where no suitable image(s) 12ₙ for a/some/all source network location(s) 14ₙ are located (and/or retrieved at steps 208 & 214) may be loaded and/or generated at/by user operable terminal(s) 20ₙ, as in the case of step 116 of preferred method 100, or may be selected, loaded and/or generated by network server 24ₙ or external server(s) 30ₙ, and then sent to user operable terminal(s) 20ₙ to be displayed within search engine GUI(s) 18ₙ in accordance with steps 218 to 222. Thereafter, preferred method continues at steps 218 to 222, before concluding or ending, as described previously in connection with the corresponding steps/block of preferred method 100 shown in FIG. 3a.

In FIGS. 4a to 6b, there is shown, in steps or stages, preferred ways (e.g. preferred methods and/or techniques) in which image(s) 12ₙ may be manipulated/processed (if necessary) for display within search engine GUI(s) 18ₙ in accordance with the preferred image processing system 10 of FIG. 1, and/or any one or more of the various steps (e.g. steps 112 or 212, etc.) of the preferred methods 100, 200, shown in FIGS. 3a & 3b (as already outlined above). Although a number of the preferred methods/techniques for manipulating/processing image(s) 12ₙ for display within search engine GUI(s) 18ₙ will be described with reference to FIGS. 4a to 6b, other preferred methods/techniques will be described/provided without reference to any specific drawing. A person skilled in the art will readily understand the operation of these other preferred methods/techniques for manipulating/processing image(s) 12ₙ in accordance with the invention, and as such, it is considered that drawings illustrating same need not be provided herein.

Referring to FIGS. 4a to 4c, there is shown one preferred method/technique for manipulating/processing (if required) an image(s) 12ₙ for display with a search engine GUI(s) 18ₙ in accordance with, e.g. step 112 or 212, of preferred methods 100, 200, shown in FIGS. 3a & 3b. Here it can be seen that when a large, wide or unusual shaped image 12ₙ (see, for example, FIG. 4a—which may be a non-transparent or partially transparent image 12ₙ) is retrieved (at step 110 or 210), that image 12ₙ may be manipulated so that the resultant image 12ₙ (FIG. 4c) may be readily or effectively displayed within a predetermined image 12ₙ display area(s) provided within search engine GUI(s) 18ₙ. To do this, the pixels or areas of the original image 12ₙ (of FIG. 4a) are initially analysed/examined in order to detect the highest variation area of pixels or no pixels (e.g. pixel colour variations or shading variations, etc.) within the image 12ₙ. For the original image 12ₙ shown in FIG. 4a, the highest pixel variation area would clearly be that in and around the “Bill's bakery” logo (i.e. the area directly to the left of the original image 12ₙ). Once the highest pixel variation area of the original image 12ₙ is determined, method 100 or 200 (at step 112 or 212), may then select an area or region 42 surrounding the highest pixel variation area, as is illustrated by way of FIG. 4b. It is preferred that the size and dimensions of area or region 42 correspond to the size and dimensions of the predetermined image 12ₙ display area(s) provided within search engine GUI(s) 18ₙ. Thereafter, and also preferably at step 112 or 212, of preferred method 100 or 200, the remaining portions of the original image 12ₙ may be removed and/or ignored, such that only the portion of original image 12ₙ provided within area or region 42 is then displayed within a search engine GUI(s) 18ₙ in accordance with the present invention, as is illustrated by way of FIG. 4c. Traditionally, wide or unusual shaped images that would not fit within an allocated image area would simply be centred for display within that allocated image area. If such a traditional technique was applied to the original image 12ₙ shown in FIG. 4a, it will be readily apparent that the resultant display of the manipulated image would result in the display of none, or only a small portion, of the high pixel variation area or region 42, of image 12ₙ, selected for display in accordance with the novel method/technique previously described in accordance with the present invention. Accordingly, the method/technique for manipulating image(s) 12ₙ for display within search engine GUI(s) 18ₙ shown in FIGS. 4a to 4c, clearly provides an improved process for determining the portion of an unusual, etc., shaped image 12ₙ that will be of most interest to a user 32ₙ.

Although not specifically shown in the drawings, an alternative preferred method/technique for manipulating/processing a large, wide or unusual shaped image 12ₙ (such as, the image 12ₙ shown in FIG. 4a—which again may be a non-transparent or partially transparent image 12ₙ) for display with a search engine GUI(s) 18ₙ in accordance with, e.g. step 112 or 212, of preferred methods 100, 200, may include allowing user's 32ₙ (e.g. web designers) to specify a pixel point within the original image 12ₙ (FIG. 4a) file name, or image 12ₙ metadata, that would then allow method 100 or 200 (of system 10) to identify which portion of the image 12ₙ should be displayed within a predetermined image 12ₙ display area(s) provided within search engine GUI(s) 18ₙ. For example, if the original image 12ₙ area is three times longer than the predetermined image 12ₙ display area provided within search engine GUI(s) 12ₙ, a web designer could specify to use the middle third of the original image 12ₙ for display within the predetermined image 12ₙ display area. If an image was, for example, 300 pixels wide, the web designer could add a code such as, for example, “_PX_100_”, to the image's 12ₙ file name, or could embed such a code within the image's 12ₙ metadata, so that method 100 or 200 could readily recognise that the desired display portion of the original image 12ₙ starts 100 pixels to the right of the first pixel within the image 12ₙ. Method 100 or 200, at e.g. step 112 or 212, could then readily choose an area or region 42 in and around the specified desired display area of the original image 12ₙ for display within search engine GUI(s) 18ₙ in accordance with the invention. This image file name, or image metadata, protocol could be made publicly available to, for example, web designers or copyright owners, so as to make it easy for them to make the relevant changes to (or to create) the file names, or metadata, of images used on their sites 14ₙ (e.g. source network location(s) 14ₙ) and to test how those images 12ₙ display quickly and easily.

Again although not specifically shown in the drawings, yet a further alternative method/technique for manipulating/processing a large, wide or unusual shaped image 12ₙ (such as, the image 12ₙ shown in FIG. 4a—which again may be a non-transparent or partially transparent image 12ₙ) for display with a search engine GUI(s) 18ₙ in accordance with, e.g. step 112 or 212, of preferred methods 100, 200, may include (e.g. as part of a bookmarking or saved links tool, etc.) allowing user's 32ₙ to determine which portion of an original image 12ₙ they would like to display within a predetermined image 12ₙ display area(s) provided within search engine GUI(s) 18ₙ. The section of the desired portion of the image 12ₙ for display being selectively adjustable by a user 32ₙ. For example, a user 32ₙ may select to adjust an image(s) 12ₙ manually using, for example, a finger or gesture movement, or mouse command, to control the portion of image(s) 12ₙ that is to be displayed from the original image(s) 12ₙ when, for example, preparing the image(s) 12ₙ for the purpose of sharing. This could be achieved by dragging an image 12ₙ, expanding an image 12ₙ or reducing an image 12ₙ using a mouse or finger gesture or voice command, etc.

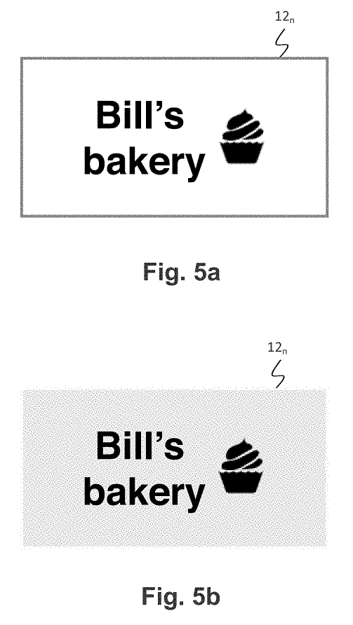

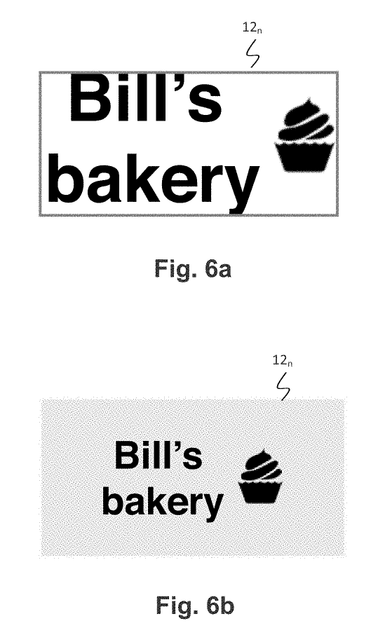

Referring to FIGS. 5a to 6b, there is shown preferred methods/techniques for manipulating/processing (if required) partially transparent image(s) 12ₙ for display with a search engine GUI(s) 18ₙ in accordance with, e.g. step 112 or 212, of preferred methods 100, 200, shown in FIGS. 3a & 3b. Here it can be seen that when an original partially transparent image 12ₙ (see, for example, FIGS. 5a & 6a) is retrieved (at step 110 or 210), that/those image 12ₙ may have one or more background colour(s), etc., added thereto (see, for example, resultant image 12ₙ of FIG. 5b), or may be manipulated as well as having one or more background colour(s), etc., added thereto (see, for example, resultant image 12ₙ of FIG. 6b), prior to that/those image 12ₙ (FIGS. 5b & 6b) being displayed within a predetermined image 12ₙ display area(s) provided within search engine GUI(s) 18ₙ. To do this, one or more pixels or areas of the original image(s) 12ₙ (of FIGS. 5a & 6a) are initially analysed/examined to determine whether or not the image(s) 12ₙ contains areas of transparent or no pixels (i.e. the image(s) 12ₙ are partially transparent image(s) 12ₙ). As soon as at least one transparent or empty pixel (or at least a predetermined amount of transparent or empty pixels) is located, the process of analysing/examining the pixel(s) or areas of the original image(s) 12ₙ preferably ends so as to speed up further processing of image(s) 12ₙ. For the original images 12ₙ shown in FIGS. 5a & 6a, all pixels other than those forming part of the “Bill's bakery” logo would be found to be transparent pixels. Once it is determined that an image 12ₙ is a partially transparent image 12ₙ, method 100 or 200 (at step 112 or 212), may then select an appropriate background colour(s) or effect, etc., that provides a desired level of contrast to the non-transparent pixels of that image(s) 12ₙ, and then add that background colour(s), etc., to the partially transparent image(s) 12ₙ, as is illustrated by way of, for example, FIGS. 5b & 6b (which will be described in further detail below). Further, and only if required, (either before, after or at substantially the same time as adding a background colour(s), etc., to partially transparent image(s) 12ₙ) method 100 or 200 (at step 112 or 212), may also manipulate the image(s) 12ₙ so as to improve the viewing experience of that image(s) 12ₙ within the allocated predetermined image 12ₙ display area(s) provided within search engine GUI(s) 18ₙ, as is illustrated by way of, for example, FIG. 6b (which will be describe in further detail below).

As already outlined above, if it is determined that one or more image(s) 12ₙ are partially transparent image(s) 12ₙ, then at step 112 or 212, of preferred method 100 or 200, a contrasting or desired background colour(s), effect(s), etc., may be added to the partially transparent image(s) 12ₙ as, for example, is illustrated by way of the resultant image(s) 12ₙ shown in FIGS. 5b & 6b. Preferred method(s)/technique(s) for adding a contrasting or desired background colour(s), etc., to a partially transparent image(s) 12ₙ in accordance with step 112 or 212, of preferred method 100 or 200, of the present invention, may include, but are not limited to: generate a specific background colour(s), etc., based on the differing requirements of each image, by way of, for example, algorithmically analysing each image(s) 12ₙ and generating a contrasting light/dark coloured background or light/dark drop shadow, visual effect, etc., for each image(s) 12ₙ that enhances the viewing experience of non-transparent pixels within the image(s) 12ₙ (for example, if it was determined that that non-transparent pixels within a partially transparent image(s) 12ₙ are black, then method 100 or 200, etc., may generate a contrasting white or other light coloured background (e.g. light grey, etc.) so as to provide contrast for the non-transparent black pixels); mining HTML, Javascript, CSS, or other types of code available at the partially transparent image(s) 12ₙ source network location(s) 14ₙ to determine which background colour(s), etc., would be most appropriate for use with the partially transparent image(s) 12ₙ—such as, for example, identifying and reusing colour(s), texture(s) or other image(s) 12ₙ used within the source network location(s) 14ₙ itself to create or recreate a background colour(s), etc., to be used with the partially transparent image(s) 12ₙ (this may include the colour themes already present within the source network location(s) 14ₙ, such as, for example, if the partially transparent image(s) 12ₙ were to have been retrieved from a Facebook page, then the background colour(s) selected and used for the partially transparent image(s) 12ₙ may be Facebook's corporate blue colour, etc., based on that colour(s), etc., being a dominant or featured colour within the source network location(s) 14ₙ); and/or, generating a specific background colour(s), shade(s) of colour(s), effect(s), etc., for a partially transparent image(s) 12ₙ based on predetermined data (e.g. preferred background colour(s), etc., data) specified within an image(s) 12ₙ file name or metadata (i.e. an image 12ₙ file name, or image 12ₙ metadata, protocol for specifying data required to generate a desired background colour(s), etc., for partially transparent image(s) 12ₙ—as will now be described in further detail below).

In accordance with a further aspect of the present invention, and as was outlined in the preceding paragraph, a novel image 12ₙ file name, or image 12ₙ metadata, protocol for specifying data required to generate a desired background colour(s), etc., for partially transparent image(s) 12ₙ, may be utilised in accordance with step 112 or 212, of preferred method 100 or 200, of the present invention. In accordance with one preferred embodiment of this novel protocol a web designer, etc., may add a code within the image(s) 12ₙ file name (or may embed same within the image(s) 12ₙ metadata) that indicates a reference to the background, followed by the background RBG values. This may include a string, such as, for example, “_BG_#000000_” specified within the image(s) 12ₙ file name or metadata. In this example, the letters “BG” are intended to indicate “background”, whilst the RGB code “#000000” is intended to represent “100% black”. The presence of such exemplary information within the image(s) 12ₙ file name or metadata would readily enable method 100 or 200, to generate a 100% black background for the respective image(s) 12ₙ. A further exemplary string that may be specified (using, e.g. a HEX code instead of an RGB code) within a partially transparent image(s) 12ₙ file name, or metadata, may include “_makebackgroundhexFFFFFF_”, which would readily indicate to method 100 or 200, that the desired background colour for the particular image(s) 12ₙ is 100% white. Further exemplary strings, etc. (not shown), may utilise colour codes other than RGB or HEX, such as, for example, the so-called: HSL; HSV; and/or, CMYK colour codes. A skilled person will appreciate these and other suitable colour codes, identification strings, naming conventions, etc., that may be used in accordance with methods 100, 200, of the present invention. Accordingly, the present invention should not be construed as limited to the specific examples provided herein. This image file name, or image metadata, protocol could be made publicly available to, for example, web designers or copyright owners, so as to make it easy for them to make the relevant changes to (or to create) the file names, or metadata, of partially transparent image(s) 12ₙ used on their sites 14ₙ (e.g. source network location(s) 14ₙ) and to test how those image(s) 12ₙ display quickly and easily within search engine GUI(s) 18ₙ.

Referring again to FIGS. 6a & 6b, it can be seen that aside from adding a contrasting or desired background colour(s), etc., to a partially transparent image(s) 12ₙ as described above, if required/desired (either before, after or at substantially the same time as adding a background colour(s), etc., to partially transparent image(s) 12ₙ) method 100 or 200 (at step 112 or 212), may also manipulate the image(s) 12ₙ so as to improve the viewing experience of that image(s) 12ₙ within the allocated predetermined image 12ₙ display area(s) provided within search engine GUI(s) 18ₙ. In accordance with one preferred embodiment, such image(s) 12ₙ may be manipulated by scanning pixels or areas of the image(s) 12ₙ so as to determine the portion, size, etc., of the non-transparent pixels in relation to the total size of the image(s) 12ₙ, and then selecting/determining the most appropriate portion of the image(s) 12ₙ to be displayed within the predetermined image(s) 12ₙ area of search engine GUI(s) 18ₙ. This preferred method/technique preferably includes the step of reducing the viewable area of the/each image(s) 12ₙ to a percentage smaller than the full width or height of the allocated predetermined image(s) 12ₙ area of search engine GUI(s) 18ₙ, so as to provide/generate a border area around the non-transparent pixels of the/each image(s) 12ₙ (thus allowing for an area of clear space to go around the non-transparent pixel area which ultimately improves the viewability and/or readability of the image(s) 12ₙ content). As part of the processing of reducing or scaling down the image(s) 12ₙ, method 100 or 200, at step 112 or 212, may also centre the non-transparent pixel content, again to improve the viewability and/or readability of the image(s) 12ₙ concerned. A skilled person will appreciate these and other suitable methods/techniques for manipulating partially transparent image(s) 12ₙ, that may be used in accordance with methods 100, 200, of the present invention, and as such, the present invention should not be construed as limited to the specific examples provided herein.

Reference will now be made to the alternative exemplary GUI's 18ₙ (e.g. search engine GUI(s) 18ₙ, as shown) shown in FIGS. 7 to 10, each of which illustrate alternative preferred constructions of various screens or pages 18ₙ that may be presented to a user 32ₙ after a search has been performed in accordance with system 10 as herein before described. Given the overlap between the exemplary search engine GUI(s) 18ₙ already discussed above with reference to FIG. 2, and each of the alternative search engine GUI(s) 18ₙ shown in FIGS. 7 to 10, a detailed discussion of these alternative preferred search engine GUI(s) 18ₙ (of FIGS. 7 to 10) need not be provided herein.

As already outlined above, in FIG. 7 there is shown an alternative exemplary search engine GUI(s) 18ₙ which illustrates a preferred way in which the actual network content (for example, the network content residing at the exemplary URL “websitedomain1.com” which corresponds to the top left activatable tile or region 38ₙ, as is indicated by the arrow pointing from that tile 38ₙ to the network content window 14ₙ), available at a selected source network location 14ₙ, may be displayed adjacent to (and hence, simultaneously with) the search results data (e.g. the activatable tile(s) or region(s) 38ₙ, and their respective image(s) 12ₙ and associated data 34ₙ, 36ₙ, if any) that is generated and displayed within search engine GUI(s) 18ₙ after a search has been performed. Again, as already outlined above, the search results data (e.g. tile(s) or region(s) 38ₙ, and their corresponding image(s) 12ₙ, and associated data 34ₙ, 36ₙ, if any) is preferably presented within a region, frame or sidebar 40ₙ, or the likes, so that the search results data (12ₙ, 34ₙ, 36ₙ, 38ₙ) remain accessible to a user 32ₙ should they wish to access and view the network content associated with a different search result (i.e. residing at a different source network location 14ₙ). Hence, a user 32ₙ may readily navigate through to one or more of the selected source network location(s) 14ₙ, by way of the one or more activatable tile(s) or region(s) 38ₙ, and then view the network content available at the selected source network location(s) 14ₙ, as desired.

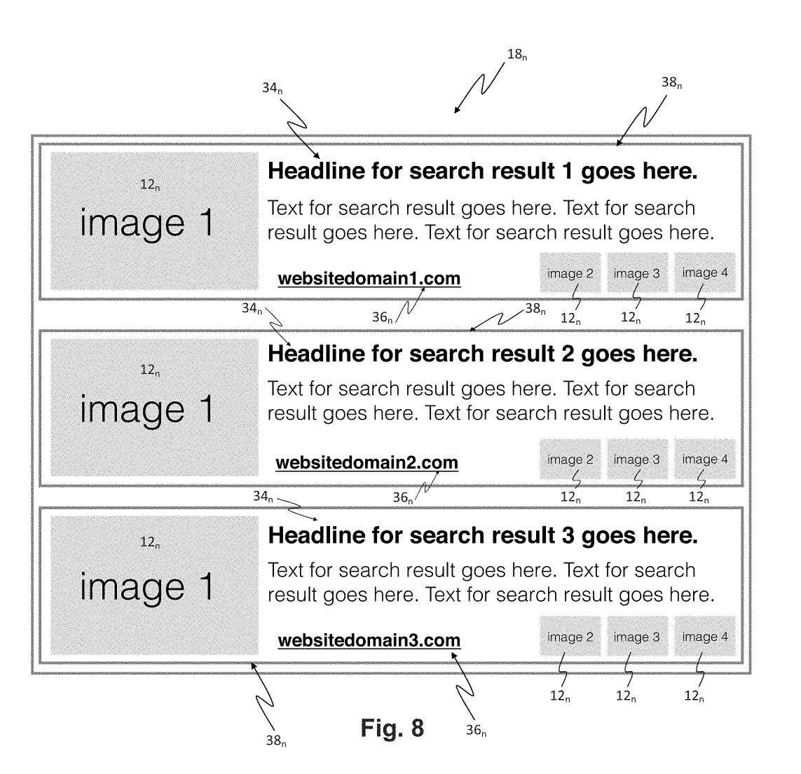

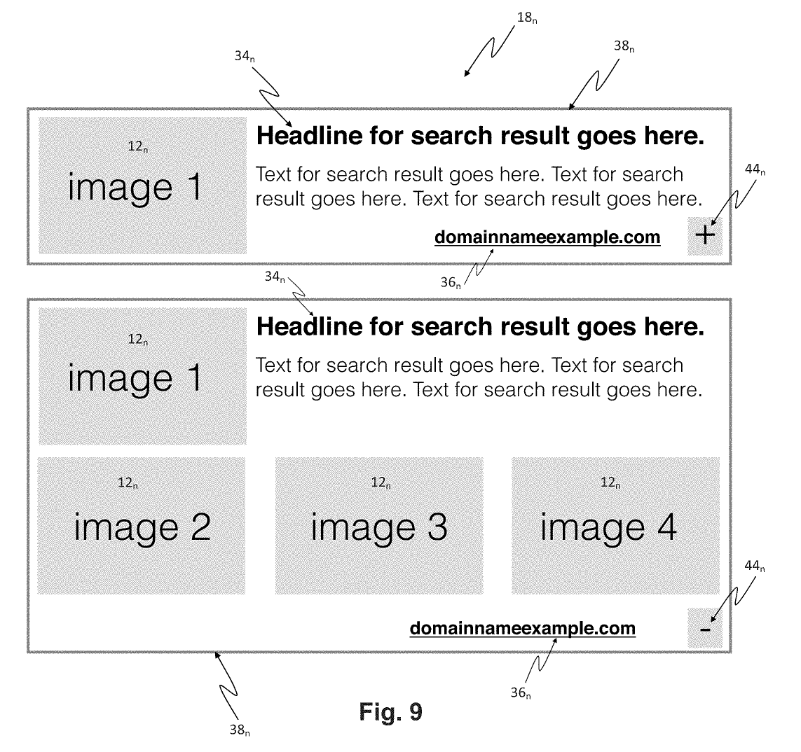

In FIGS. 8 & 9, there is shown further alternative exemplary search engine GUI(s) 18ₙ, each of which illustrates a preferred way in which multiple image(s) 12ₙ may be processed and displayed alongside (desired or required) associated search results data (e.g. text-based search results or associated data 34ₙ and/or address/URL data 36ₙ, if any) after a search has been performed. In the preferred embodiment shown in FIG. 8, it can be seen that within exemplary search engine GUI(s) 18ₙ, aside from the main larger image(s) 12ₙ (entitled “image 1” in FIG. 8) disposed at the left hand side of each activatable tile(s) or region(s) 38ₙ, each activatable tile(s) or region(s) 38ₙ may also include/display one or more additional image(s) 12ₙ (for example, three additional images as shown, but which image(s) 12ₙ may vary in number from tile(s) 38ₙ to tile(s) 38ₙ, depending on, for example, the amount of, if any, suitable image(s) 12ₙ that were located at each associated source network location(s) 14ₙ, etc.) disposed at, for example, the right hand side of each activatable tile(s) or region(s) 38ₙ. In an alternative embodiment, and as shown in FIG. 9, instead of occupying space within the primary view of the activatable tile(s) or region(s) 38ₙ, displayed within exemplary search engine GUI(s) 18ₙ, the one or more additional image(s) 12ₙ (again, three as shown, but which may vary in number from tile(s) 38ₙ to tile(s) 38ₙ, depending on, for example, the amount of, if any, suitable image(s) 12ₙ that were located at each associated source network location(s) 14ₙ, etc.), may be disposed within a portion of an activatable tile(s) or region(s) 38ₙ which is initially hidden (i.e. collapsed, etc.) from view within search engine GUI(s) 18ₙ, but which may be selectively or automatically revealed (i.e. expanded, etc.) by way of selecting or otherwise activating (e.g. using a keystroke, mouse click, gesture, voice command, etc.) a button or region 44ₙ, etc., disposed within each activatable tile(s) or region(s) 38ₙ.

In FIG. 10, there is shown yet a further alternative exemplary search engine GUI(s) 18ₙ, which illustrates a preferred way in which only multiple image(s) 12ₙ (and possibly associated address or URL search results data 36ₙ, if desired) may be displayed after a search has been performed. In this further alternative embodiment, like in the case of the exemplary search engine GUI(s) 18ₙ shown in FIG. 9, instead of occupying space within the primary view of the activatable tile(s) or region(s) 38ₙ, displayed within exemplary search engine GUI(s) 18ₙ, the one or more additional image(s) 12ₙ (again, three as shown, but which may vary in number from tile(s) 38ₙ to tile(s) 38ₙ, depending on, for example, the amount of, if any, suitable image(s) 12ₙ that were located at each associated source network location(s) 14ₙ, etc.), may be disposed within a portion of an activatable tile(s) or region(s) 38ₙ which is initially hidden (i.e. collapsed, etc.) from view within search engine GUI(s) 18ₙ, but which may be selectively or automatically revealed (i.e. expanded, etc.) by way of selecting or otherwise activating (e.g. using a keystroke, mouse click, gesture, voice command, etc.) a button or region 44ₙ, etc., disposed within each activatable tile(s) or region(s) 38ₙ. As already outlined above, this exemplary search engine GUI 18ₙ may be adopted in instances where it is desired to only visually display (by way of, for example, an augmented reality device(s), etc.) the one or more image(s) 12ₙ, retrieved from one or more source network locations 14ₙ, to a user 32ₙ, with the corresponding search results data and/or any desired associated image(s) 12ₙ data being audibly conveyed to a user 32ₙ by way of one or more sound emitting device(s) of (or connected to) the user operable terminal 20ₙ (or augmented reality device(s), etc.).

The present invention therefore provides novel and useful image processing systems and/or methods suitable for use in identifying, retrieving and processing one or more images from one or more source network locations for display within a search results screen or page of a search engine GUI(s) after a search has been performed. Many advantages of the present invention will be apparent from the detailed description of the preferred embodiments provided hereinbefore. Examples of those advantages including, but are not limited to: the ability to retrieve and process images (and/or associated image data) in real-time, or as close to real-time as possible, and hence, not being required to create an index of stored images beforehand; seamless processing and displaying of images (and/or associated image data) to user's in response to search queries (whether user, or user operable terminal, generated search queries); simultaneous display of search results, including one or more image(s), and network content available at a selected one of the source network locations corresponding to a search result presented within a search engine GUI(s) after a search has been performed; and/or, improved methods/techniques for processing and/or manipulating images, including partially transparent images, retrieved from one or more source network locations, for display at one or more target network locations.

While this invention has been described in connection with specific embodiments thereof, it will be understood that it is capable of further modification(s). The present invention is intended to cover any variations, uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the attached claims. Various modifications and equivalent arrangements are intended to be included within the spirit and scope of the invention. Therefore, the specific embodiments are to be understood to be illustrative of the many ways in which the principles of the present invention may be practiced.

Where the terms “comprise”, “comprises”, “comprised” or “comprising” are used in this specification, they are to be interpreted as specifying the presence of the stated features, integers, steps or components referred to, but not to preclude the presence or addition of one or more other features, integers, steps, components to be grouped therewith.

1. A method for identifying, retrieving and/or processing one or more images from one or more source network locations for display at one or more predetermined target network locations, the method including the steps of: acquiring an address for each of the one or more source network locations; perusing data available at each of the one or more source network locations to identify one or more images suitable for display at the one or more target network locations; retrieving any images identified as being suitable for display at the one or more target network locations; processing the retrieved images, as required or desired, in order to adapt the images for display at the one or more target network locations; and, selectively displaying the retrieved and/or processed image or images at the one or more target network locations.

2. The method of claim 1, wherein the step of acquiring an address for each of the one or more source network locations includes: performing a network and/or database search in response to a search query; identifying one or more source network locations that contain data related to the search query; and, obtaining at least the address for each of the one or more source network locations that were identified as part of the network and/or database search.

3. The method of claim 2, further including the step of: obtaining and/or compiling text-based search results data from/for each of the one of more source network locations that were identified as part of the network and/or database search.

4. The method of claim 3, wherein the step of perusing data available at each of the one or more source network locations to identify one or more images suitable for display at the one or more target network locations includes: utilising the acquired address or addresses to send network crawlers or algorithmic commands to each of the one or more source network locations to identify and analyse any available images for suitability for display at the one or more target network locations.

5. The method of claim 4, further including the step of: obtaining and/or compiling text-based data associated with one or more images identified and analysed at each of the one or more source network locations.

6. The method of claim 5, wherein the text-based data associated with the one or more images identified and analysed at each of the one or more source network locations includes: text-based data extracted from metadata of the one or more images; text-based data associated with and displayed alongside the one or more images at their respective one or more source network locations; and/or, text-based data extracted from metadata contained within modules, fields, graphic tiles, blocks or regions provided at the respective one or more source network locations.

7. The method of claim 1, wherein the step of identifying one or more images suitable for display at the one or more target network locations includes one or more of the following processes: utilising advanced data mining, deep learning, machine learning and/or artificial intelligence to make informed decisions about the existence and suitability of any images available at each source network location; mining source code data and/or embedded link data available at each source network location to determine the size and order of any available images in order to make decisions about the most appropriate or suitable image or images available at each source network location; utilising individual or aggregated user data to make determinations about the most appropriate or suitable image or images available at each source network location; ignoring images of a predetermined and/or unusual shape and/or size; recognising any advertisements and/or third party embedded logos at each source network location and ignoring any images associated with the/those advertisement/third party logos in favour of the selection of other images available at each source network location; utilising one or more image tagging protocols to determine the existence and suitability of any images available at each source network location; scanning and/or analysing metadata of any available image or images to determine the most appropriate or suitable image or images available at each source network location; and/or, analysing and comparing the characteristics of any available images to that of the characteristics of offensive images to make determinations about the most appropriate or suitable image or images available at each source network location.

8. The method of claim 1, wherein the step of retrieving any images identified as being suitable for display at the one or more target network locations includes: selectively compressing or reducing the size of the image or images prior to or during retrieval so as to reduce computational overhead or bandwidth usage.

9. The method of claim 5, wherein if it is determined that there is no suitable image or images available at one or more of the source network locations then the method further includes the step of: obtaining and/or generating a predetermined image or images for each of those source network locations so that the predetermined image or images may be displayed at the one or more target network locations.

10. The method of claim 1, wherein if it is determined that one or more suitable moving images are available at one or more of the source network locations then the method further includes the steps of: acquiring the identification sting or source location details for each of the moving images; obtaining and/or generating a thumbnail or other suitable image for each of the moving images for display at the one or more target network locations; and, utilising the acquired identification string or source location details to enable each of the moving images or a portion thereof to be selectively or automatically played at the one or more target network locations by way of selective or automatic activation of the respective thumbnail or other suitable image.

11. The method of claim 1, wherein the step of processing the retrieved images, as required or desired, in order to adapt the images for display at the one or more target network locations includes one or more of the following processes: analysing the pixels of each image to determine the highest variation area of pixels, selecting a region of predetermined dimensions surrounding the highest pixel variation area, and then adapting each image by removing the portions of each image that are outside of the selected region; analysing the file name and/or metadata of each image in order to locate a specified predetermined pixel point which identifies a desired portion of the image that is to be used for display at the one or more target network locations, selecting a region of predetermined dimensions surrounding the specified predetermined pixel point, and then adapting each image by removing the portions of each image that are outside of the selected region; allowing one or more users to select a region of predetermined dimensions surrounding a desired area of each image, and then adapting each image by removing the portions of each image that are outside of the selected region; analysing one or more pixels of each image to determine whether or not an image contains areas of transparent or no pixels, and if it is determined that an image contains areas of transparent or no pixels, adapting the image by adding a predetermined contrasting background colour(s) and/or effect(s) to the image; and/or, analysing the pixels of any partially transparent images in order to determine the portion and/or size of the non-transparent pixels in relation to the total size of the image, selecting a region of predetermined dimensions surrounding the most appropriate portion of the image which contains non-transparent pixels, and then adapting each image by removing the portions of each image that are outside of the selected region.

12. The method of claim 11, wherein the predetermined contrasting background colour(s) and/or effect(s) that is added to one or more of the images determined to contain areas of transparent or no pixels is selected, generated and/or added by way of one or more of the following processes: analysing the non-transparent pixels of the respective image and generating and adding a contrasting coloured background, or drop shadow or visual effect, to the image which enhances the viewing experience of the non-transparent pixels of the image; mining source code data available at the source network location that corresponds to the respective image, and generating and adding a contrasting coloured background, or drop shadow or visual effect, to the image which corresponds to, or complements, a theme or dominant feature of other data residing at the source network location; and/or, analysing the file name and/or metadata of the respective image in order to locate specified predetermined background information which identifies a desired background colour(s), or drop shadow or visual effect that is to be used with that image, and generating and adding a contrasting coloured background, or drop shadow or visual effect, to the image which corresponds to that specified predetermined background information.

13. The method of claim 11, wherein the process of analysing the pixels or areas of any partially transparent images in order to determine the portion and/or size of the non-transparent pixels in relation to the total size of the image, selecting a region of predetermined dimensions surrounding the most appropriate portion of the image which contains non-transparent pixels, and then adapting each image by removing the portions of each image that are outside of the selected region, further includes one or both of the following steps: reducing the viewable area of the portion of the image that corresponds to the selected region, to a percentage smaller than the full width and/or height of the predetermined dimensions, so as to generate a border area around the non-transparent pixels of each image; and/or, centering the non-transparent pixel content within the selected region of predetermined dimensions prior to removing the portions of each image that are outside of the selected region.

14. The method of claim 9, further including the step of: selectively and/or temporarily storing the retrieved and/or processed image or images, the obtained and/or generated predetermined image or images, the text-based search results data, the text-based data associated with the one or more images identified and analysed at each of the one or more source network locations, and/or data pertaining thereto, in at least one repository, so as to streamline future processing in instances where the same source network locations are identified as part of a future network and/or database search.

15. The method of claim 9, wherein the one or more target network locations include one or more network and/or database search applications or GUIs residing on one or more user operable terminals.

16. The method of claim 15, wherein the step of selectively displaying the retrieved and/or processed image or images at the one or more target network locations includes: selectively displaying the retrieved and/or processed image or images, and/or the obtained and/or generated predetermined image or images, within the one or more network and/or database search applications or GUIs after a network and/or database search has been performed.

17. The method of claim 16, wherein for each source network location that was identified as part of the network and/or database search, the retrieved and/or processed image or images, and/or the obtained and/or generated predetermined image or images, that correspond to that source network location are disposed within at least one activatable tile or region which when selectively or automatically activated links through to the respective source network location.

18. The method of claim 17, further including the step of: for each source network location that was identified as part of the network and/or database search, selectively displaying the obtained text-based search results data and/or the obtained text-based data associated with the one or more images identified and analysed at the source network location, alongside the corresponding retrieved and/or processed image or images, and/or the corresponding obtained and/or generated predetermined image or images, within the at least one activatable tile or region.

19. The method of claim 17, further including the step of: for each source network location that was identified as part of the network and/or database search, audibly conveying the obtained text-based search results data and/or the obtained text-based data associated with the one or more images identified and analysed at the source network location, upon request, or upon it being determined that a user is viewing the corresponding retrieved and/or processed image or images, and/or the corresponding obtained and/or generated predetermined image or images, disposed within the at least one activatable tile or region.

20. The method of claim 17, wherein upon selective or automatic activation of the at least one activatable tile or region corresponding to a selected source network location, network content available at that selected source network location is displayed alongside, and simultaneously with, at least selected ones of the activatable tiles or regions so that those activatable tiles or regions remain accessible to a user should they wish to access and view network content associated with a different source network location.

21. The method of claim 20, wherein the activatable tiles or regions are disposed within a region, sidebar or frame of the one or more network and/or database search applications or GUIs.

22. A non-transitory computer readable medium storing a set of instructions that, when executed by a machine, cause the machine to execute a method for identifying, retrieving and/or processing one or more images from one or more source network locations for display at one or more predetermined target network locations, the method including the steps of: acquiring an address for each of the one or more source network locations; perusing data available at each of the one or more source network locations to identify one or more images suitable for display at the one or more target network locations; retrieving any images identified as being suitable for display at the one or more target network locations; processing the retrieved images, as required or desired, in order to adapt the images for display at the one or more target network locations; and, selectively displaying the retrieved and/or processed image or images at the one or more target network locations.

23. A system for identifying, retrieving and/or processing one or more images from one or more source network locations for display at one or more predetermined target network locations, the system including: one or more modules or applications for acquiring an address for each of the one or more source network locations and/or one or more modules, applications or functions for selectively activating one or more external modules or applications for returning an acquired address for each of the one or more source network locations; one or more modules or applications for perusing data available at each of the one or more source network locations and for identifying and retrieving one or more images suitable for display at the one or more target network locations; one or more modules or applications for processing the retrieved images, as required or desired, in order to adapt the images for display at the one or more target network locations; and, one or more modules or applications for selectively displaying the retrieved and/or processed image or images at the one or more target network locations.

24. A method for selecting a desired region of an image to be displayed at one or more predetermined target network locations, the image having specified predetermined pixel point information included within its file name and/or metadata which identifies the desired region of the image that is to be used for display at the one or more target network locations, the method including the steps of: analysing the file name and/or metadata of the image in order to locate the specified predetermined pixel point information; selecting a region of predetermined dimensions surrounding, or adjacent to, the specified predetermined pixel point information; and, adapting the image by removing the portions of the image that are outside of the selected region so that only the desired region of the image may then be displayed at the one or more predetermined target network locations.

25. A method for generating and adding a desired contrasting background colour(s) and/or effect to a partially transparent image, the partially transparent image having specified predetermined background information included within its file name and/or metadata which identifies the desired contrasting background colour(s) and/or effect, the method including the steps of: analysing the file name and/or metadata of the image in order to locate the specified predetermined background information; and, generating and adding a contrasting coloured background and/or effect to the image which corresponds to that specified predetermined background information.
